(19) United States
(12) Patent Application Publication
(10) Pub. No.: US 2022/0402390 A1
(43) Pub. Date: Dec. 22, 2022

(54) A MULTIMODAL CONVERTER FOR INTERFACING WITH MULTIPLE ENERGY SOURCES

(71) Applicant: INVERTEDPOWER PTY LTD, Heidelberg West, Victoria (AU)

(72) Inventor: Stefan SMOLENAERS, Heidelberg West (AU)

(21) Appl. No.: 17/756,039

(22) PCT Filed: Nov. 13, 2020
(86) PCT No.: PCT/AU2020/051236

§ 371 Date: May 13, 2022

(30) Foreign Application Priority Data
Nov. 14, 2019 (AU) 2019904294
Mar. 30, 2020 (AU) 2020900973
Oct. 16, 2020 (AU) 2020903767

(51) Int. Cl. B60L 53/22; H02M 3/158; B60L 53/10; B60L 53/122; B60L 53/50

(52) U.S. Cl. CPC B60L 53/22; H02M 3/1586; B60L 53/11; B60L 53/122; B60L 53/50; B60L 2210/12; B60L 2210/14; B60L 2210/30

(57) ABSTRACT

A multimodal converter for use in electric vehicle charging stations for interfacing between at least one AC source and two DC sources (including the electric vehicle with onboard DC traction accumulator). The multimodal converter may also be applicable to other uses with a multitude of energy sources. For example, where the multimodal converter AC interface is for an electric motor, such as in a plug-in electric vehicle, an electric power tool, an electric water pump, a wind turbine, or the like, or interfacing with any DC sources such as an electrical battery apparatus, a solar panel array, a DC generator, or the like, whether for private, commercial or other use.

### TECHNICAL FIELD

The present disclosure relates to a power electronic AC-DC, DC-AC, and/or DC-DC multimodal converter for an inductive load.

The disclosure has been developed primarily for use in electric vehicle charging stations for interfacing between at least one AC source and two DC sources (including the electric vehicle with onboard DC traction accumulator) and will be described hereinafter with reference to that application. However, it will be readily appreciated that the disclosure is not limited to these particular fields of use and may also be applicable to other uses with a multitude of energy sources. For example, the disclosure may be applied in applications where the multimodal converter AC interface is for an electric motor, such as in a plug-in electric vehicle, electric power tool, electric water pump, wind turbine, or the like, or interfacing with any DC sources such as an electrical battery apparatus, solar panel array, DC generator, or the like, whether for private, commercial or other use.

### BACKGROUND

Any discussion of the background art throughout the specification should in no way be considered as an admission that such art is widely known or forms part of common general knowledge in the field.

An electric converter is a well-known device to transfer power from one load to another, whilst performing a voltage and/or current translation. Certain applications benefit from the ability to selectively draw or deliver power to a range of different power sources or sinks based on conditions. Such conditions could include the intermittency of power generation such as a solar PV panel, or of a load, such as an electric appliance recharging at a charging station. In traditional applications, each conversion would be implemented using dedicated converters, which may or may not be used concurrently. In occurrences where the converter is not required for the intermittent purpose, it can be inversely repurposed to perform another task or conversion. This enables higher utilisation of the converter which improves economics and sustainability of products. If the inverse intermittent purpose requires a different conversion type (for example, ACDC rectification versus DCDC conversion), then a multimodal converter design is necessary.

An example is an electric vehicle fast charging station, which includes a primary source of electricity of the AC grid, and a further DC source (e.g. solar PV, or stationary battery), and an intermittent vehicle load which interfaces to the charger to accept a recharge. The high-power requirements of fast charging mean a strong grid connection is required to satisfy the power requirements. Such a power supply is often not available requiring costly upgrades to the electricity network. Furthermore, the typical low duty cycle of electric vehicle charging leads to a poor load factor of the network assets, and therefore requires significant over capitalisation of the asset. In most regions, the network operator discourages this behaviour by applying peak demand charges to the customer to pass on some of this incurred cost. This discourages charge point operators from installing high-powered chargers, as the resulting cost per use is high due to low load factor until high penetration of electric vehicles are achieved. On the other hand, high penetration of electric vehicles will not occur until sufficient fast charging infrastructure is deployed. One solution to overcome this is to accumulate energy in an energy storage device at a lower power rate, and then use the energy of the storage device to fast charge the vehicle at a higher power rate. Since most energy storage devices are of DC voltage (e.g. battery), such a solution requires the ability to charge a DC storage device from the grid via an AC to DC rectification conversion, and then charge the vehicle's DC battery from the DC storage device in a DC to DC conversion. The charging station should also be able to charge the vehicle directly from the grid at lower power when high power charging is not required. In some applications, it may be beneficial to charge the electric vehicle by deriving energy from both the AC grid and DC storage simultaneously. When charging a vehicle from another DC source, such as a stationary battery, sometimes the vehicle voltage is higher, and sometimes lower, therefore the charging should ideally be able to act in multiple modes to either increase (boost) or decrease (buck) the voltage in DC to DC mode. To perform all of these modes with traditional solutions requires having multiple converters each dedicated to performing a single task. This adds significantly to the cost and footprint of charging stations. Therefore, a multimodal converter is required to be able to provide the versatility of conversions between power sources and sinks without adding significantly to the cost and footprint.

Furthermore, in a charging station, interoperability between vehicles is important to ensure a range of vehicles can couple to the charging station to receive a charge. For this, numerous charging standards have evolved to enable compatibility between different vehicle makes and models. Still, electric vehicle technology is evolving, and numerous vehicle types and generations exist, which lead to a range of vehicle voltages, charging power levels, currents, and the like. Vehicle-to-grid (V2G) technology is also becoming an important factor for the future. Therefore, in some applications it is desirable for the charging station to accommodate vehicles of widely different power and voltage levels bidirectionally. That is, the converter should operate in four-quadrant (“4Q”) operation to ensure voltage can be stepped-up (boosted), or stepped-down (bucked) in either direction between at least two of the sources or loads. Furthermore, the standards include requirements for current and voltage ripple, and the charging station must comply with grid standards such as total harmonic distortion (THD), and electro-magnetic compatibility (EMC). These requirements make filtering of the different input and outputs important. Charging stations are also mainly privately funded, and therefore cost and footprint of the charging station is another important factor—therefore the charging station must optimise use of every component available in each conversion process to optimise power density and avoid additional size or cost. This places a heavy burden on any converter to have a cost-effective solution with acceptable THD and EMC, whilst maintaining a high efficiency wide voltage range output with low current and voltage output ripple.

Some prior-art have tried to tackle elements of this problem, but none provide an entirely satisfactory solution. For example, Rayner application U.S. Pat. No. 10,097,078 describes a number of multi-modal converters topologies which are able to charge an electric vehicle from an AC or DC source, but none are able to satisfactorily accommodate a wide-voltage output in DC to DC mode (e.g. four-quadrant operation) and a high-powered filtered output with minimal components.

Accordingly, there is a need in the art for an improved multimodal converter for interfacing with multiple energy sources.

### SUMMARY

It is an object of the present disclosure to overcome or ameliorate at least one of the disadvantages of the prior art, or to provide a useful alternative.

In one form the disclosure provides a multimodal converter for an inductive load including: a converter of one or more drive circuit phases connected to one or more inductive load phases; an interface to an AC current source or sink of one or more phases; an interface to an DC current source or sink; an interface to a further DC current source or sink; a switching mechanism; and a controller which operates in a first state and a reconfigured, second state; wherein in the first state the controller uses the switching mechanism to selectively connect the inductive load phases to the AC one or more phases such that a filtered AC load current can be drawn and rectified by the converter to supply DC power to either one of the DC current sources or sinks; wherein in the reconfigured second state the controller uses the switching mechanism to selectively disconnect at least one inductive load phase from at least one of the phases of the AC interface, and use the drive circuit phases of the converter to transfer a DC current through at least one of the inductive load phases between the two interfaces of DC current sources or sinks; and wherein the DC input and the DC output of the conversion is filtered.

A multimodal converter where the second state of the multimodal converter is reconfigured into a four-quadrant DCDC converter that is able to selectively operate in at least one of a buck mode, a boost mode, a bidirectional buck mode and a bidirectional boost DC to DC conversion mode between the DC current source or sink and the further DC current source or sink. The multimodal converter has interfaces for two DC sources, and one AC source, and wherein the converter is able to control power flow direction between any two sources.

The switching mechanism includes a first switching mechanism for selectively connecting the first DC interface, and a second switching mechanism for selectively connecting the second DC interface, wherein in the first state the controller enacts or causes to act either the first switching mechanism or the second switching mechanism.

A multimodal converter where in the second state, the switching mechanism includes a third switching mechanism to connect at least one of the one or more inductive loads which was disconnected from the AC interface to at least one of the DC interfaces. The inductive load has two or more phases, and the third switching mechanism is able to connect at least one of the two or more phases to the first DC interface, and another phase to the second DC interface simultaneously.

A multimodal converter where in in the second state, at least two of the inductive load phases are selectively electrically bridged on the side not connected to the drive. A multimodal converter where in in the second state at least one of the inductive loads are selectively coupled to at least one of the DC source or sink interfaces.

The multimodal converter defines at least in part an electric vehicle charging station, and wherein one of the DC current source or sink is an electric vehicle coupled to the charging station. The multimodal converter provides a filtered output of continuous current to the electric vehicle. The multimodal converter defines at least in part an electric vehicle charging station, and wherein the further DC current source or sink is an attached or coupled with a DC energy storage system. A converter where multiple converters are able to operate in parallel.

According to an aspect of the disclosure there is an electric vehicle charging station including; an active rectifier of one or more phases, at least one inductive load for each phase, a connection to an AC energy source or sink, a connection to a DC energy source or sink integrated in or connected to the charging station, a coupler for coupling with an electric vehicle including a DC energy source, a switching mechanism, and a controller for operating the charging station wherein; in a first mode of operation, the charging station draws energy from the AC grid and supplies it to the DC energy source, and wherein in a second mode of operation the stations draws energy from the DC energy source and supplies it to an electric vehicle coupled to the charging station

According to another aspect of the disclosure, the disclosure provides a controller for an electric vehicle charging station connected to both an AC and a DC source of energy. Wherein the controller orchestrating multiple multi-modal converters where each converter can act independently in ACDC, bidirectional DCDC, or DCAC modes. Wherein the controller is able to selectively control the modes of each of the converters to charge an electric vehicle while drawing a dynamic amount of power of the grid, or attached DC storage.

According to another aspect of the disclosure, the disclosure provides a controller for a multi-modal converter comprised of multiple smaller converters, for transferring power between a first DC source, a second DC source, and an AC source. Wherein a first mode of operation, the controller is able to charge the first DC source from the AC source, and in a second mode of operation, the controller is able to the charge the second DC source using energy from both the first DC source and AC source simultaneously.

According to another aspect of the disclosure the disclosure provides a controller for an electric vehicle charging station. The electric vehicle charging station includes of a converter able to act in AC to DC rectification mode, a converter able to act in a DC to DC conversion mode, a DC input for coupling with a DC source, a DC output for coupling with an electric vehicle, an AC input for coupling with an AC source, and a switching mechanism. Wherein, the controller can selectively couple the DC input to either the output of the AC to DC converter or to the input of the DC to DC converter. Wherein the controller can output a regulated DC current or voltage to the DC output using energy derived from the AC input and the DC input simultaneously.

According to another aspect of the disclosure, the disclosure provides a controller for the DC to DC converter, where the converter can selectively operate in buck, boost, or boost-buck modes to provide a versatile DC voltage or current translation from a first DC source to another DC source.

According to another aspect of the disclosure, the disclosure enables a high-power DC output for an electric vehicle which is able to draw upon multiple DC sources. For example, the electric vehicle may be able to draw from the energy stored within a further DC source (for example, a stationary battery) attached to or integrated within the charging station, and/or from the energy produced by a solar panel array attached to or integrated within the charging station, and/or from the energy derived from the AC macro-grid (for example, through use of an AC to DC rectifier and/or DC to DC converter).

According to another aspect of the disclosure there is a charging station comprised of multiple converters and multiple input and output sources, wherein the converters are able to be orchestrated to jointly act to perform a variety of modes. Wherein the charging station has at least one of; an interface to an AC source; an interface for charging an electric vehicle; a further DC source interface, for example a battery or solar panel array. Wherein the multitude of converters can be used to transfer power between at least the AC interface and the electric vehicle interface, the AC interface and the further DC source, and the further DC source interface and the electric vehicle interface.

According to another aspect of the disclosure for a charging station for an electric vehicle, there exists a switching mechanism for selectively outputting a unregulated DC source for an electric vehicle with onboard DC converter, or selectively outputting a regulated charging current or voltage for an electric vehicle without an onboard DC converter.

According to an aspect of the disclosure, there is a charging station for an electric vehicle including a converter between an AC or DC source and at least one of an electric vehicle interface and/or a further DC interface for interfacing with a further DC energy source such as a battery. Wherein the charging station includes a switching mechanism that the converter can supply at least one of a regulated current or a regulated voltage to the further DC interface or to the electric vehicle interface, or both. According to another aspect of the disclosure.

According to another aspect of the disclosure there is a charging station including multiple converters connected to a common DC bus, and two or more electric vehicle interfaces. According to an aspect of the disclosure, each electric vehicle interface is connected to the common DC bus via a DCDC converter. According to another aspect of the disclosure, each DCDC converter can operate to provide at least one of a regulated current or voltage translation between the common DC bus and the electric vehicle, or between the common DC bus and a further DC source such as a stationary battery. According to one aspect of the disclosure, one or more switching mechanisms are employed to determine whether the DCDC converter interfaces to the electric vehicle or to the further DC source, or both simultaneously. According to another aspect of the disclosure, the DCDC converter can operate to return current back to the common DC bus as sourced from at least one of the electric vehicle or the further DC source.

According to a further aspect to the disclosure there is an electric vehicle connected to the DC bus, which can receive at least one of a regulated charging current or voltage by controlling other converters connected to the DC bus, or use an onboard DC charger onboard the vehicle to charge directly from the DC bus in an unregulated mode. In one aspect of the disclosure, the DC bus includes a DC storage element such as a battery pack, where current or voltage may be regulated in or out of the DC storage element by controlling the other converters connected to the DC bus. According to an aspect of the disclosure, at least all but one of the interfaces to the common DC bus have the ability to determine the current flow, and wherein the controller can orchestrate each of the converters such that currents can be balanced and controlled. In one aspect of the disclosure, the DC bus includes an ACDC interface to an AC source, and two or more DCDC converters interfacing to an electric vehicle and/or storage device.

According to one aspect of the disclosure, there exists a controller for an electric vehicle charging station with an ACDC converter, a DCDC converter, an AC interface, an electric vehicle interface, and a further DC interface. Where in embodiments the controller can selectively act to charge a source connected to the further DC interface from the source connected to the AC interface, or to charge an electric vehicle at the electric vehicle interface from the AC interface, or the electric vehicle from the further DC interface, or the electric vehicle from the AC interface and the further DC interface simultaneously. Wherein the charging station further includes a switching mechanism, wherein the further DC interface and the electric vehicle interface can be selectively coupled by the switching mechanism without transferring power through one of the converters.

According to another aspect of the disclosure, there exists a controller for an electric vehicle charging station with two or more electric vehicle outputs, with each of the electric vehicle outputs with at least one corresponding converter and one further DC source and a switching mechanism, wherein the output to the electric vehicle can be selectively regulated by the converter, or unregulated by connecting the electric vehicle output and the further DC source together.

Wherein in some embodiments in some modes of operation, the corresponding converter and further DC source of one electric vehicle output can be used to supply power to another electric vehicle output when the corresponding components are operating in bidirectional mode.

Wherein the same converter can be used to either supply or draw current to or from an electric vehicle, and/or the further DC source by selective use of the switching mechanism.

Wherein in another aspect of the disclosure, the controller orchestrates multiple converters to transfer power between at least two of; the AC interface, an electric vehicle, a further DC source, another electric vehicle, and another further DC source.

Wherein according to another aspect of the disclosure, the controller can orchestrate multiple converters to balance currents on a common AC or DC bus such as to selectively and/or proportionally draw current or energy from multiple energy sources to service the load requirements.

Wherein according to another aspect of the disclosure, the controller can orchestrate multiple converters to balance currents on a common DC bus such as to regulate the draw or supply of current to an otherwise unregulated DC interface.

Wherein according to another aspect of the disclosure, the output of one converter corresponding to one electric vehicle interface can be coupled to the output of another electric vehicle interface for the purposes of increasing power output.

According to another aspect of the disclosure there exists a controller for an electric vehicle charging station including: an interface to an AC current source or sink, an interface to an DC current source or sink, an interface to an electric vehicle, a multimodal converter including a switching mechanism, and a controller which operates in a first state and a second state, wherein: in the first state the controller uses the multimodal converter to draw current from the AC source or sink, to provide at least one of a regulated current or voltage to the DC current source or sink; and wherein the second state the controller uses the multimodal converter to connect the interface of the DC current source or sink with the interface of the electric vehicle such that the electric vehicle can use an onboard converter to regulate at least one of a regulated charging current or voltage.

According to another aspect of the disclosure there exists a controller for an electric vehicle charging station including: two or more DC interfaces and two or more corresponding electric vehicle interfaces, a common power supply bus, one or more converters connected between two or more of the DC interfaces and/or electric vehicle interfaces and the common power supply bus, a further DC interface for an electric vehicle or a storage device connected to the common power supply bus, and a controller which operates in a first state and a second state, wherein; in the first state the controller uses the converters to draw current from the common power supply bus to provide at least one of a regulated current or voltage to at least one of the DC interfaces and/or the corresponding electric vehicle interfaces; and wherein the second state the controller uses at least one of the converters to draw energy from at least one of the DC interface and/or corresponding electric vehicle interface to provide at least one of a regulated current or voltage to the further DC interface.

Reference throughout this specification to “one embodiment”, “some embodiments” “an embodiment”, “an arrangement”, “one arrangement” means that a particular feature, structure or characteristic described in connection with the embodiment, arrangement and/or variation is included in at least one embodiment, arrangement and/or of the present disclosure. Thus, appearances of the phrases “in one embodiment”, “in some embodiments”, “in an embodiment”, “in one arrangement”, or “in and arrangement” in various places throughout this specification are not necessarily all referring to the same embodiment or arrangement, but may. Furthermore, the particular features, structures or characteristics may be combined in any suitable manner, as would be apparent to one of ordinary skill in the art from this disclosure, in one or more embodiments or arrangements.

As used herein, and unless otherwise specified, the use of the ordinal adjectives “first”, “second”, “third”, etc., to describe a common object, may merely indicate that different instances of objects in a given class of objects are being referred to, and are not intended to imply by their mere use that the objects so described must be in a given sequence, either temporally, spatially, in ranking, in importance or in any other manner.

Unless defined otherwise, all technical and scientific terms used herein have the same meaning as commonly understood by those of ordinary skill in the art to which the disclosure belongs. The articles “a” and “an” are used herein to refer to one or to more than one (that is, to at least one) of the grammatical object of the article unless the context requires otherwise. By way of example, “an element” normally refers to one element or more than one element. As used herein, the term “exemplary” is used in the sense of providing examples, as opposed to indicating quality. That is, an “exemplary embodiment” is an embodiment provided as an example, as opposed to necessarily being an embodiment of exemplary quality.

Further forms of the disclosure are as set out in the appended claims and as apparent from the description.

### BRIEF DESCRIPTION OF THE FIGURES

Embodiments of the disclosure will now be described, by way of example only, with reference to the accompanying drawings in which:

FIG. 1 is an overview representation of an electric vehicle charging station with multiple input and output sources and sinks

FIG. 2 is a schematic of a circuit diagram to a buck-boost multimodal converter which may be applied or configured to the electric vehicle charging station of FIG. 1.

FIG. 3 is a schematic of a circuit diagram to a boost-buck multimodal converter which may be applied or configured to the electric vehicle charging station of FIG. 1.

FIG. 4A is a schematic of a circuit diagram to another boost-buck multimodal converter with further operational modes which may be applied or configured to the electric vehicle charging station of FIG. 1.

FIG. 4B is schematic of a circuit diagram to a multimodal boost-buck DC to DC converter which may be applied to configurations of the electric vehicle charging station of FIG. 1.

FIG. 5 is a schematic of a circuit diagram to another boost-buck multimodal converter with a reconfigurable transformer winding which may be applied or configured to the electric vehicle charging station of FIG. 1.

FIG. 6 is a schematic of a circuit diagram to a transformer-less boost-buck multimodal converter which may be applied or configured to the electric vehicle charging station of FIG. 1.

FIG. 7 is a schematic of a circuit diagram to another boost-buck multimodal converter with alternative connections which may be applied or configured to the electric vehicle charging station of FIG. 1.

FIG. 8 is a schematic of a circuit diagram to another boost-buck multimodal converter employing further filtering which may be applied or configured to the electric vehicle charging station of FIG. 1.

FIG. 9 is a schematic of a circuit diagram to a single-phase multimodal converter which may be applied or configured to the electric vehicle charging station of FIG. 1.

FIG. 10 is a schematic of a circuit diagram to a boost or buck multimodal converter which may be applied or configured to the electric vehicle charging station of FIG. 1.

FIG. 11 is an overview representation of an alternative electric vehicle charging station comprised of multiple multimodal converters.

FIG. 12 is an overview representation of an alternative electric vehicle charging station comprised of multiple multimodal converters with further electric vehicle interfaces.

FIG. 13 is an overview representation of an alternative electric vehicle charging station comprised of multiple multimodal converters with further interfaces for DC sources.

FIG. 14 is an overview representation of an alternative electric vehicle charging station comprised of multiple multimodal converters with further interfaces for electric vehicles and DC sources.

FIG. 15 is an overview representation of a bidirectional distributed energy resource of DC energy generation and DC storage elements.

FIG. 16 is an overview representation of an electric vehicle charging station with an ACDC converter and a DCDC converter operating together to provide multimodal operation between an AC source and two DC sources.

FIG. 17 is an overview representation of an electric vehicle charging station with a multimodal converter and a DCDC converter operating together to provide multimodal operation between an AC source and two DC sources.

FIG. 18 is an overview representation of an electric vehicle charging station with an ACDC converter and a DCDC converter operating together to provide multimodal operation between an AC source and two DC sources, and an optional third DC source.

FIG. 19 is an overview representation of an electric vehicle charging station with an ACDC converter for interfacing with up to two electric vehicles and a further DC source.

FIG. 20 is an overview representation of an electric vehicle charging station with an ACDC converter and a DCDC converter for an AC source, an electric vehicle, and a further DC source.

FIG. 21 is an overview representation of an alternative electric vehicle charging station with an ACDC converter and a DCDC converter for an AC source, an electric vehicle, and a further DC source.

FIG. 22 is an overview representation of an electric vehicle charging station with an ACDC converter and a DCDC converter for an AC source, an electric vehicle, and two further DC sources.

FIG. 23 is an overview representation of an electric vehicle charging station for multiple electric vehicles, each with a further DC source.

FIG. 24 is an overview representation of an electric vehicle charging station for multiple electric vehicles each with a further DC source, based on a common DC bus architecture.

FIG. 25 is a schematic of another charging station for an electric vehicle for charging from either an AC source at AC interface.

### DETAILED DESCRIPTION

Example embodiments and variations of the disclosed disclosure will be described in detail herein.

The multimodal converter disclosure has been developed primarily for use in electric vehicle charging stations for interfacing between at least one AC source and two DC sources (including the electric vehicle with onboard DC traction accumulator) and will be described hereinafter with reference to that application. However, it will be readily appreciated that the disclosure is not limited to these particular fields of use and may also applicable to other uses with a multitude of energy sources. For example, the disclosure may be applied in applications where the multimodal converter AC interface is for an electric motor, such as in a plug-in electric vehicle, electric power tool, electric water pump, wind turbine, or the like, or interfacing with any DC sources such as an electrical battery apparatus, solar panel array, DC generator, or the like, whether for private, commercial or other use.

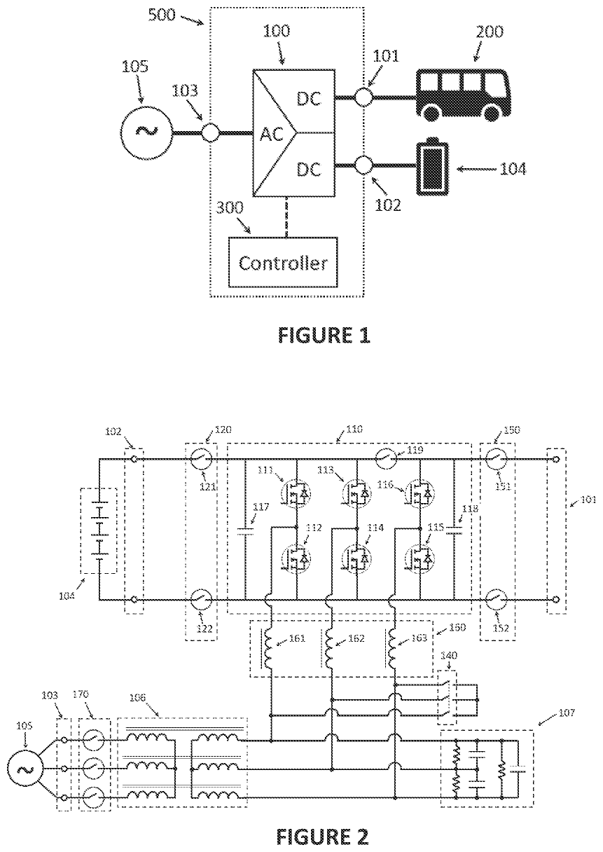

FIG. 1 is an overview representation of a multimodal converter 100 as applied in the configuration of an electric vehicle charging station 500. The multimodal converter 100 interfaces to: an AC electrical source represented as electrical grid 105 connected to AC interface 103; a DC source or sink represented as electric vehicle (EV) 200 connected to a DC interface 101; and a further DC source or sink represented as energy storage system (ESS) 104 connected to further DC interface 102. The multimodal converter 100 is capable of performing AC to DC, or DC to DC conversions between two or more of the sources or sinks. The operation of converter 100 is controlled by control signals issued by controller 300. In some embodiments, controller 300 is also able to communicate with any of the sources or sinks to provide or receive instructions, commands, feedback, or information. For example, communication with the electric vehicle 200, and/or the battery management system (BMS) of storage 104, and/or the electrical grid 105, and/or a backend system or cloud application. Controller 300 or converter 100 may also have circuitry or other methods to sense the nature, condition, or state of any of the attached sources or loads. Controller 300 can then ensure it only draws or supplies current or voltage within the specified limitation of each of the energy sources or sinks. Controller 300 can also determine, or in communication with a further controller, which conversions are required, and the intended energy source, and energy sink of the conversion. Such decisions of operational modes can be used, for example; to optimise conversions, improve efficiency, reduce electricity costs, improve load factor, satisfy local demand constraints, reduce peak demands, participate in demand response, aggregate with other charging stations, provide bidirectional power or ancillary grid services, or the like.

Using attached storage 104, controller 300 is able to provide peak shaving and load shifting operations. For example, controller 300 can store energy from the AC grid in storage 104 when there is a surplus of energy, or at a low power sustained rate, and later use the energy from storage 104 in a brief high powered DC to DC conversion to charge vehicle 200. In this way, charging station 500 is able to present a desirable higher load factor with lower peak demand on grid 105, whilst still enabling a high-power output to charge vehicle 200.

In some embodiments, charging station 500 is a fixed charger, and storage 104 is integrated into, or permanently attached to, the station.

In some embodiments storage 104 is a pack of batteries or ultra-capacitors, or other DC storage mechanism. In some embodiments, storage 104 is a 2^{nd} life battery application, such as consisting of one of more batteries which have been previously used as a traction battery onboard an electric vehicle.

In other embodiments, storage 104 is a DC generation device such as a photovoltaic (PV) solar panel array, wind generator, or the like.

In some embodiments, charging station 500 is a mobile charger, with or without wheels, or fitted to a vehicle with wheels. In some embodiments, storage 104 is integrated into the charging station 500, or is also mobile and intended to travel with the charging station 500. In some embodiments, charging station 500 operates to charge vehicle 200 from storage 104 without the requirement to be connected to an AC source 105.

FIG. 2 is an overview representation of an example multimodal converter 100 as implemented in electric vehicle charging station 500 of FIG. 1. Common conventional components of an electric vehicle charging station have been omitted for clarity. The station has a DC coupler 101 for selectively coupling with electric vehicle 200, another DC coupler 102 for connecting with DC energy storage system (ESS) 104, and an AC coupler 103 for connecting with AC energy source 105. In this embodiment energy storage device 104 is a bank of stationary batteries, and AC energy source 105 is a 3-phase AC electrical grid, but in other implementations other energy sources, storage devices, and sinks are possible. The present embodiment includes a transformer 106 for galvanic isolation, but in other embodiments it is not implemented. In the present embodiment, the converter 100 includes an inductor 161, 162, 163 connected to each of the 3-phases of a 3-phase drive 110. In other embodiments, other numbers of phases are used. The converter 100 is equipped with switching mechanisms to selectively connect and disconnect the different sources to be used in the intended conversion. For example, the charging station converter 100 has a switching mechanism 170 to selectively connect or disconnect the AC coupler 103 (and transformer 106, and filter 107, if equipped) from the 3-phase drive. The charging station 100 is also able to selectively connect or disconnect the DC coupler 102 from the drive 110 using switching mechanism 120, and EV coupler 101 from the drive 110 using switching mechanism 150. Depending on the conversion mode the controller 300 also has the ability to selectively connect together all three of the inductors together into a star-point using three-phase switching mechanism 140. In this embodiment, the switching mechanisms are represented as contactors, however in other embodiments they are implemented using other switch types.

Multimodal converter 100 can act in AC to DC, DC to AC, or DC to DC modes. The drive 110 includes a switching mechanism 119 which determines the conversion mode of the drive. When operating in AC to DC, or DC to AC modes, the controller 300 selectively engages (that is, closes) switch 119 and switches 170, and disengages (that is, opens) switching mechanism 140. The controller 300 then engages either switches 120 or switches 150 to enable charging of the DC storage device 104, or EV 200 respectively. In some operational modes, the controller engages both switches 120 and 150 to enable power flow between the DC coupler 102, EV coupler 101, and the AC coupler 103. This mode is particularly relevant when the electric vehicle 200 has a further inline DC to DC converter onboard able to regulate the current between itself and charging station 500.

When operating in DC to DC mode, the controller 300 selectively disengages switch 119 and switches 170, and engages switching mechanism 140, and both switching mechanisms 120 and 150. This configuration allows for controller 300 to control drive 110 in either buck, boost, or cascaded buck-boost DC to DC modes, using the inductance of 163, and either or both of inductors 161 and 162.

When performing a conversion from DC coupler 102 to EV coupler 101, drive switches 111 and/or 113 are used as buck switches, and drive switch 115 is used as a boost switch. Each switch is controlled by controller 300 with pulse width modulation to achieve the desired response. When performing a conversion from EV coupler 101 to DC coupler 102, drive switch 116 is used as a buck switch, and switches 112 and/or 114 are used as boost switches. In this way, the charger can perform a bidirectional buck-boost conversion between EV coupler 101 and DC coupler 102.

The star point created by switching mechanism 140 ensures that the sum of the currents of all three inductors are equal to zero, and therefore, in contrast to the teaching of prior-art by Rayner, enables a magnetically coupled three-phase filter to be used. Furthermore, the star point provides an asymmetrical layout, enabling interleaving of the three-phase load using drive switches 110 to improve power performance and/or reduce output ripple when compared with Rayner. In addition, the creation of the star point by switching mechanism 140 enables a range of filter circuits 107 to be used (exemplarily shown as a delta RC connected network) between the inductor set 160 and the secondary winding of transformer 106. When further compared with Rayner, the power rating of the drive 110 is improved in the export buck (that is charging the EV 200 of a lower voltage from ESS 104 of a higher voltage) and import boost (that is charging the ESS 104 of a higher voltage from EV 200 of a lower voltage) by splitting the DC bus capacitance to enable bulk capacitance across the DC bus on either side of switch 119. Furthermore, splitting the DC bus capacitance mitigates the effect of the stray inductance of the DC bus of drive 110 during AC to DC and DC to AC conversions as caused by the addition of switch 119. Therefore, irrespective of the inductor setup used in the DC to DC conversion, having capacitance on either side of switch 119 eliminates at least one of the aspects to be able to selectively connect ESS 104 or EV 200 to the other side of the DC bus as disclosed by Rayner. Splitting of the DC bus link capacitance may however reduce the maximum RMS ripple rating able to be absorbed by the bulk capacitance in export boost and import buck modes. In this case, the power rating is able to be restored in four-quarters by employing an interleaving strategy, thereby reducing the current ripple seen by the capacitors for a given duty cycle. Therefore, the magnetically coupled sine filter 160 combined with the filter circuit 107 provide a superior result for rectification and inversion, whilst the split DC capacitors and interleaving strategy provide a superior conversion result for DC to DC conversions when compared with prior art solutions. This leads to a robust multimodal converter in accordance with the spirit of the disclosure described herein.

In the present embodiment, the main bulk capacitance of drive 110 is split into two capacitor banks 117 and 118, each formed by one or more capacitors. The split of the capacitance between 117 and 118 is dependant per application and design. In some embodiments, the capacitance of 117 is the same as 118 to achieve an equal split of the bulk capacitance during DC to DC modes. In other embodiments, capacitance is split ⅔^{rd}s to capacitor 117, and ⅓^{rd} to capacitor 118, representative of an equal capacitance per phase of drive 110. In the present embodiment, capacitance is split in favour of capacitor 118 (for example, ⅔rds to capacitor 118) in recognition that during DC to DC conversions the current ripple by the single switching leg (made up of switches 115 and 116) imposed on capacitor 118 may be higher than that of capacitor 117 due to the inability for the single switching leg to perform interleaving. That is, due to the asymmetrical layout caused by switch 119, an interleaving strategy may be employed which benefits ripple on capacitor 117 but not capacitor 118, therefore capacitor 117 is able to have a lower RMS ripple current rating than capacitor 118.

Controller 300 operates the drive switches 111, 112, 113, 114, 115, and 116 by switching them on or off, or in a pulse width modulation (PWM) operation. Controller 300 also controls all of the switching mechanisms, including 120, 140, 150, 170 and the like. Controller 300 may operate converter 100 using voltage and/or current feedback loops using either scalar, vector, or hybrid control algorithms. To assist with the control algorithms, converter 100 may have current and/or voltage sensors or communicated feedback for at least two of the three phases, the DC interfaces at 102 and 101, the AC interfaces at 103, and/or points internal to the drive 110. Furthermore, temperature of crucial components may be monitored to enable a power derating schedule.

In low power operational modes, controller 300 may operate switches 111 and 113, or 112 and 114 singularly to reduce switching losses and increase conversion efficiency. This conversion power threshold for example could be determined by the RMS current ripple capacity of the capacitors 117 and/or 118.

In AC to DC mode, controller 300 acts converter 100 as a 3-phase boost rectifier circuit using the inductance of boost inductors 161, 162, and 163. Controller 300 opens switch 140 and closes switch 170 and either of 120 or 150, and uses switches of drive 110 to perform active 3-phase rectification of the input voltage from AC interface 103. In DC to AC mode, controller 300 similarly uses drive switches 110 as an inverter to create a three-phase AC output. In some embodiments, controller 300 acts as a synchronous rectifier or inverter, synchronising with the frequency of grid 105.

The inductors 161, 162, 163 can be mutually coupled or discrete inductors. For the present embodiment, mutually coupled inductors can act as a 3-phase sine filter in conjunction with filter 107, to filter AC when in DC to AC, or AC to DC modes. When operating in DC to DC modes, a star point is created via switching mechanism 140 such that there are no zero sequence currents and therefore mutually coupled inductors provide acceptable characteristics.

In other embodiments, switches 140 comprise of just two switches 141 and 142. The switch 141 (connecting inductors 161 and 162) may be implemented with half the current rating of switch 142 (connecting inductors 162 and 163).

Filter 107 is shown as a delta connection RC network, but other configurations of filters are possible, such as a wye connection, or using other elements. In some cases, filter 107 is comprised of, or includes in addition to, an EMC/EMI high frequency filter. Some embodiments include a filter with capacitance to ground. In some embodiments, the filter to ground has a further switching mechanism to selectively connect and disconnect the filter connection to ground. In other embodiments, a further AC filter is employed between the switches 170 and the primary winding of transformer 106.

In further embodiments, AC source is other than 3-phases, or includes a neutral wire.

In the present embodiment, converter 100 employs a switching mechanism 170 to disconnect the transformer 106 from the AC interface 103 during DC to DC operational modes. The switching mechanism 170 can also be used to lower or eliminate idle current draw during periods when converter 100 is not required to perform any function.

In a further embodiment, AC source 105 is able to be selectively connected and disconnected from the AC coupler 103 by a further switching mechanism 130 [not shown] located between the filter 107 and inductors 160. In this way, multiple converters can be attached to the same AC transformer, either through a common secondary winding, or by using galvanically isolated individual secondary windings. In some embodiments, switching mechanism 130 replaces the need for the switching mechanism 170.

In the present embodiment, switching mechanisms 120 and 150 are illustrated with double pole switching uses switches 121 and 122, and 151 and 152 respectively. In other embodiments, just a single pole switch is used to limit the total amount of switches. In some embodiments, switching mechanism 150 remains double pole to meet relevant electric vehicle charging station standards.

In further embodiments, charging station 100 is a mobile charging station, such as fitted with wheels, or onboard another vehicle. In such cases, the AC source 105 might only be used to recharge the integrated storage 104 at a base, and then mobilised once internal storage 104 has sufficient charge to charge a vehicle. In such cases, the AC grid 105 is not expected to charge the EV directly, and therefore no galvanic isolation is required, and the transformer 106 can be eliminated to reduce cost, weight, and size.

In other implementations where galvanic isolation is not required, the transformed is also eliminated.

In implementations where transformer 106 is eliminated, a further inductor set 165 may be employed as replacement to the transformer windings to create an LCL filter network.

In implementations where inductors 161, 162, and 163 are not mutually coupled, or where the inductance of transformer 106 is low, further inductor set 165 may be employed between filter 107 and transformer 106 to create an LCL filter.

In a further mode of operation, converter 100 is able to connect the DC voltages of 101 and 102 by closing both switching mechanisms 120 and 150. In such instances where there is a voltage differential between the two, an unregulated current will flow to the lower potential source/sink. If EV 200 attached to DC coupler 101 has an onboard means of DC to DC regulation, it may act to regulate the current or voltage sources or sunk by EV coupler 101. In this mode, controller 300 can act to control the ratio of EV coupler 101's current sourced or sunk by ESS 104 or grid 105 by closing switching mechanism 170 and opening switch 140 and switching the drive circuits to source or sink current to grid 105. In this mode, charging station 500 provides an unregulated output to EV 200, where EV 200 is able to charge itself using current sourced from both ESS 104 and grid 105.

During start-up phase controller 300 must pre-charge the capacitors 117 and 118 of drive 110 to limit inrush currents when closing the main switching mechanisms. Traditionally this would require a pre-charge or soft-start circuit for each source. In some embodiments, controller 300 can use the pre-charge circuit of a single source to pre-charge capacitors to the level required for a further source. For example, if the AC input voltage of 105 is 400 VAC and transformer has a 1:1 winding, then the capacitors 117 and 118 of drive 110 should be at least 566 VDC to avoid an unregulated current inrush when switches 130 are closed. In embodiments where a DC pre-charge system [not shown] exists in parallel to switching mechanism 120, and the voltage of storage 104 exceeds 566 VDC then this can be used to sufficiently pre-charge capacitors 117 and 118 prior to the closing switches 170. In some embodiments, storage 104 is selected to be at a higher voltage than the rectified voltage of the AC source 105 as applied through any voltage translation of transformer (in this example equal to roughly 566 VDC), to enable storage 104 to be able to receive a regulated charging current from grid 105. In embodiments with a pre-charge circuit in parallel to switches 120; during the start-up of DC to DC mode from DC interface 102 to DC interface 101, controller 300 can pre-charge capacitor 117 from the pre-charge circuit, and then operate in DC to DC buck-boost voltage mode to pre-charge capacitor 118 from DC source 104 using the switches of drive 110 and inductors 161 and/or 162, and 163.

As improved converter 100 is able to provide a wide voltage output in DC to DC operational mode due to the ability of buck and boost conversions, the DC voltage of ESS 104, and the corresponding AC voltage (including step voltage of transformer 106) may be maximised to improve the power rating of converter 100. For example, the maximum DC voltage of ESS (e.g. 100% state of charge voltage) may be sized as close as possible to the maximum rating of converter 100, and the AC voltage (including any step of transformer 106) may be sized to provide a rectified voltage equal to, or just below, the minimum voltage of ESS 104 (e.g. 0% state of charge voltage). Assuming the converter power is limited by current, the maximising of voltages improves the power density of converter 100 by increasing power output per unit of current.

In other embodiments, switch 119 is located on the DC power rail between switch 111 and 113. In other embodiments switch 119 is located on the negative power rail between any of the half bridge drive circuits.

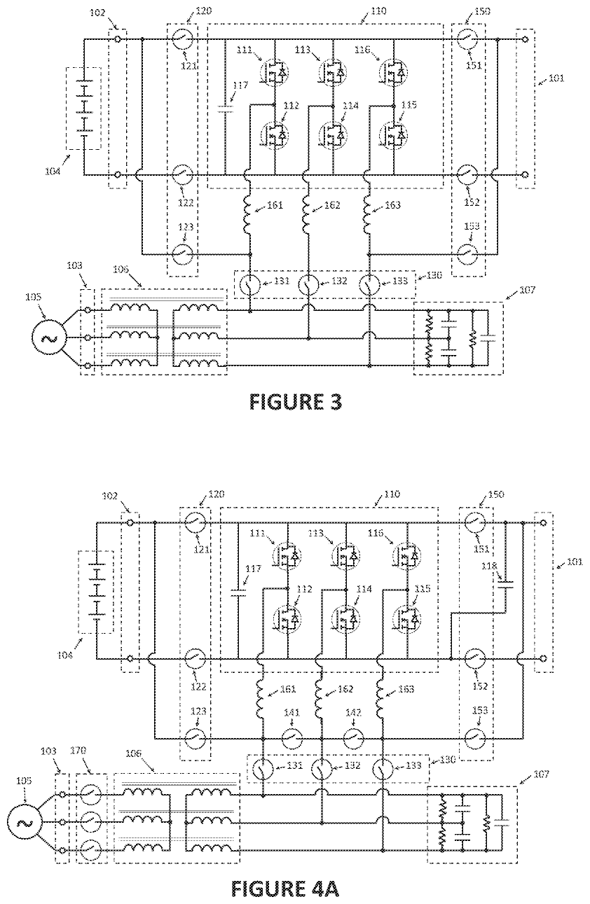

FIG. 3 is a schematic of a circuit diagram of another multimodal converter 100 that may be applied or configured to the electric vehicle charging station 500 of FIG. 1. In this embodiment, a standard 3-phase drive 110 is used, without the requirement of switch 119 as illustrated in FIG. 1. This utilises off-the-shelf drive hardware, where just custom software is required.

In contrast to the prior-art, the present embodiment provides improved functionality with fewer components. One such example of improved functionality includes the bidirectional boost-buck operational modes, where the inductors 161 and 163 operate as input and output filters during DC to DC conversions. This provides the significant benefit of providing continuous currents on both the input and output, thereby reducing the requirement of furthering filtering outside (or inside) of converter 100 and thus may reduce the cost and footprint of charging station 500. Furthermore, the converter may, in some aspects, also be able to act in four-quadrant operation, providing buck, boost, bidirectional buck, and bidirectional boost DC to DC modes whilst always providing filtering at the input and output. This enables charging compatibility with a wide range of DC energy storage or sources coupled at DC interface 102, and electric vehicles coupled at DC interface 101.

In the present embodiment, converter 100 includes three inductors 161, 162, and 163 which are able to be disconnected from the phases of AC interface 103 (illustrated in this embodiment via transformer 106) using switches 131, 132 and 133 respectively. The switching mechanism 130 (consisting of switches 131, 132, and 133) also disconnects the inductors from the filter network 107, and the secondary winding star-point of transformer 106.

In DC to DC modes, controller 300 opens switching mechanism 130 and engages switches 122 and 123 of switching mechanism 120, and switches 152 and 153 of switching mechanism 150. When charging EV 200 from ESS 104, controller 300 may operate switch 112 to perform a boost conversion from ESS 104 using inductor 161 on to capacitor 117 of drive 110. Controller 300 may simultaneously operate switch 116 to perform a buck conversion from capacitor 117 of drive 110 to EV 200 at DC coupler 101. In this way, controller 300 may perform a sequential boost then buck conversion using capacitor 117 as an intermediary buffer. Therefore, ESS 104 and EV 200 receive continuous currents as filtered by inductors 161 and 163 respectively, with the discontinuous currents created by the conversion imposed on capacitor 117. This is in contrast to the teaching of Rayner where each conversion processes may create discontinuous or ripple currents on either the input or output, which may require further strategies for filtering or ripple mitigation. Furthermore, containing the high frequency ripple currents within an earthed enclosure of drive 110 may improve the EMC and EMI compliance of the charger 500. In addition, in the present embodiment controller 300 can operate switch 112 and 116 in a singular, synchronised, interleaved, or offset manner based on feedback or timing to improve the efficacy of the conversion. For example, controller 300 may coordinate to turn on switch 116 as soon as, or a little prior to turning switch 112 off, such that the bulk of the current drawn through inductor 163 is supplied by the boost current of inductor 161. In another example, controller 300 elects to provide modulated switching to either but not both of switches 112 or 116, depending on the required input or output voltages or currents. Controller 300 may also operate different switches at differences switching frequencies to optimise the ripple current imposed on capacitor 117, or to improve other factors of the conversion.

For instances or applications where a sequential boost-buck conversion is not required (for example, there is sufficient difference in voltage between ESS 104 and EV 200), controller 300 may operate converter 100 as a boost or buck converter to reduce switching losses, while maintaining the input and output filter inductances. That is, controller 300 may elect to not implement PWM switching to either the boost or buck switching component of the boost-buck conversion. For example, controller 300 may provide a DC to DC conversion from ESS 104 to EV 200 without providing PWM control to both drive switch 112 and 116. In one such operational mode of charging EV 200 from a lower voltage ESS 104, controller 300 keeps switch 116 on (100% buck duty cycle) during the conversion process and uses switch 112 to regulate the conversion current or voltage. In another operational mode of charging EV 200 from a higher voltage ESS 104, controller 300 keeps switch 112 off, and optionally switch 111 on (synchronous operation) to bypass the voltage drop of the freewheeling (anti-parallel) diode of switch 111, and uses switch 116 to regulate the voltage or current of the conversion. This conversion process may also happen in the other direction to charge ESS 104 from EV 200 by using switch 115 as the boost switch (or 116 to bypass the freewheeling diode), and switch 111 as the buck switch.

From herein, the switching modes of sequential boost then buck conversions, including buck or boost conversions where corresponding switches are held at 100% duty cycle (including the bypassing of freewheeling diode using the upper switch of the boost half-bridge phase), will be referred to as boost-buck modes.

Other buck or boost operational modes of converter 100 are also possible for instances or applications where discontinuous or ripple currents are allowed, or having an inductive element on the input or output is undesirable (for example, when at risk of approaching the fundamental frequency of an effective LC tank). For example, controller 300 is also able to use switches 121 or 151 to bypass either the input or output inductance during buck or boost DC to DC modes. For example, when charging EV 200 from ESS 104, controller 300 is able to close switches 121, 122, 152 and 153, and open switches 151 and 130, to perform a buck conversion using switch 116. In the same state, controller 300 can charge ESS 104 from EV 200 using switch 115 as a boost switch. In the same way, controller 300 can use switches 122,123 and 151,152 to perform the inverse boost or buck functionality depending on the voltage levels of ESS 104 and EV 200.

In some operational modes, controller 300 operates buck and boost switching legs synchronously to reduce voltage drop of the freewheeling (anti-parallel) diodes. That is, for example, when using switch 116 as a buck switch, switch 115 is switched inversely to switch 116 to provide the buck current of inductor 163, thereby bypassing the freewheeling diode component of switch 115. In the same way, for example, when using switch 112 as a boost switch, switch 111 can be switched inversely to bypass the freewheeling diode of switch 111.

In AC to DC and DC to AC modes, controller 300 closes switching mechanism 130 and operates drive 110 to perform a controlled rectification or inversion respectively. Controller 300 closes switches 121 and 122, or 151 and 152 to direct the power flow to ESS 104 or EV 200 respectively.

Through the switching of drive switches 111-116, controller 300 is able to issue signals to control converter 100 to operate bidirectionally in buck, boost, or boost-buck modes.

In some embodiments switch 132 of switching mechanism 130 is not employed, however, in embodiments without transformer 106 switch 132 may be included to provide galvanic isolation of EV 200 from grid 105 during DC to DC conversion modes.

In some embodiments, extra protection, safety elements, or filtering are provided such as fuses, further switches, diodes, capacitors, over-voltage and over-current protection circuits, over-temperature protection circuits, redundancy control mechanisms, failure mode protection, common mode (CM) filtering, differential mode (DM) filtering, pre-charge circuitry, and the like. For example, anti-parallel diodes may be selectively employed during DC to DC mode to ensure safe operation by absorbing current of the inductors if the input or output loads are suddenly disconnected during operation.

In embodiments, capacitance 117 of drive 110 may be pre-charged before full power is applied via switching mechanisms 130 (or 170), 120, or 150. In some embodiments, drive 110 is pre-charged from a single source (for example, ESS 104 or grid 105), to provide the pre-charge necessitated to enter other modes. For example, in some embodiments, converter 100 has an AC soft-start circuit in series with the AC phases and in parallel with switches 130 (or 170). In this way AC currents are limited while the capacitance 117 is pre-charged near the rectified voltage of the applied AC voltage (including any voltage translation of transformer 106). If the capacitor needs to be pre-charged to a high voltage, for example, to accommodate a higher DC voltage of ESS 104, then controller 300 may use the active rectification switches of drive 110 to increase the voltage further to the same voltage of ESS 104 or EV 200, before closing the switches 120 or 150 respectively. In another embodiment, a DC pre-charge circuit is located in parallel to switching mechanism 120 to charge capacitor 117 from ESS 104. If further pre-charging is required (for example, to accommodate a higher voltage from EV 200), then controller 300 can use the active DC to DC boost function of switching mechanism 120 and drive switch 112 to perform a boost conversion on to capacitor 117 to raise its voltage to the required voltage level of EV 200. In most applications, ESS 104 should be designed to be at a higher voltage than the rectified AC power, and therefore no further boosting of capacitor voltage 117 is required after pre-charging from ESS 104 to enable the connection to grid 105 via switch 130 (or 170). In other embodiments, multiple pre-charge, soft-start, or other circuits are used to ensure safe operation of converter 100.

In the present embodiment, filter 107 is shown as a delta RC network, however in other implementations the filter consists of another filter type.

In another embodiment or version, switch 121, and/or switch 151 is not employed. In such embodiments, the circuit and operation of controller 300 is simplified and operational modes are limited. In embodiments without switch 121, controller 300 is unable to directly charge ESS 104 from grid 105, but is still able to maintain DC to DC bidirectional operation to charge EV 200 at DC output 101 from ESS 104 at DC input 102. Similarly, in embodiments without switch 151, controller 300 is unable to charge EV 200 at DC output 101 from grid 105, but is still able to maintain bidirectional DC to DC operation between ESS 104 and EV 200.

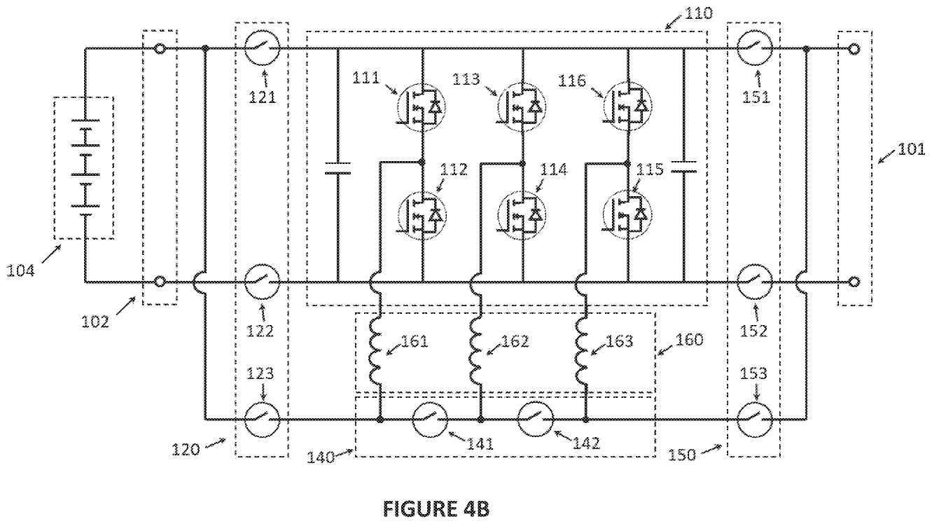

FIG. 4A is a schematic of a circuit diagram of another multimodal converter 100 that may be applied or configured to the electric vehicle charging station 500.

In this embodiment, the inductors 163, and/or 162, and/or 161 may be able to be selectively coupled via switches 141 and/or 142 to enable optimised combinations of multiple parallel DC to DC current paths. This enables controller 300 to either operate in boost-buck mode as per the previous illustration, or in a boost-buck mode where either the boost or the buck conversion component is paralleled, or in a parallel boost or buck conversion mode. For example, in a DC to DC conversion between ESS 104 and EV 200, controller 300 could close switch 141 and operate drive switches 112 and 114 as boost switches (either in tandem or interleaved), and switch 116 as a buck switch. Alternatively, controller 300 could close switch 142 and operate switch 112 as a boost switch, and switches 113 and 116 as buck switches (either in tandem, or interleaved). In this way, controller 300 may optimise the switching ripple imposed on capacitor 117 to increase power capability, improve conversion efficiency, reduce input or output ripple, improve EMC or EMI compliance, or any other measure of conversion efficacy. In boost-buck modes, maximum power is still limited by the limitation of a single-phase leg of either the drive switches or inductors. In a further mode of operation, power output may be increased by performing only a buck or boost conversion using phases in parallel and bypassing the input or output inductor. For example, when providing a step-up/boost charge from ESS 104 to EV 200, controller 300 may close switches 141 and/or 142, 122, 123, 151 and 152, and open switching mechanism 130 and/or 170, and regulate the conversion using drive switches 112, 114, and/or 115 together or interleaved, to perform a parallel boost conversion. When performing a buck charge from ESS 104 to EV 200, controller 300 may close switches 141 and/or 142, 121, 122, 152 and 153, and open switching mechanism 130 and/or 170, and regulate the conversion using drive switches 111, 113, and/or 116 together or interleaved, to perform a parallel buck conversion. These buck and boost operations can also be performed in the other direction to charge ESS 104 from EV 200.

In a mode of operation for providing a boost-buck conversion from DC coupler 102 to EV coupler 101, controller 300 selectively engages switches 122, 123, 152, 153, and optionally 141 or 142, and disengages switches 121, 151, 130 and optionally 170. In this mode, drive circuit switch 112 (and/or 114 if 141 is engaged) acts as a boost switch, and switch 116 (and/or 113 if 142 is engaged) acts as a buck switch. In some operational modes, controller 300 bypasses the boost operation by leaving the boost switch off, and optionally turning on the top switch of the boost switching half-bridge phase to bypass the upper freewheeling diode. In some operational modes, controller 300 bypasses the buck operation by operating the buck switch at 100% duty cycle. In boost-buck operational modes where either the buck or boost component is bypassed, controller 300 may improve efficiency or other characteristics of the DC to DC conversion.

In scenarios when the voltage of ESS 104 excess EV 200, controller 300 may act converter 100 as a buck converter with two or more phases in parallel to charge EV 200 from ESS 104 at high power while maintaining output inductance. In this mode, controller 300 closes switches 121, 122, 142 (and optionally 141), 152 and 153 and opens switches 123, 151, 130 and/or 170. Controller 300 then uses drive switches 113 and 116 (and 111 if switch 141 is closed) in parallel conversions to provide a buck conversion from DC interface 102 to EV interface 101. Controller 300 may optionally employ an interleaving strategy for the switches to provide reduced input current ripple imposed on capacitor 117.

In parallel boost, or buck modes, controller 300 acts to perform conversion in parallel, thereby increasing the power output of the conversion. If the DC bus capacity of converter 110 is increased, then the output rating of converter 100 operating in DC mode may exceed the output power capability of the converter 100 operating in ACDC mode. This enables the controller 300 to use storage 104 as an energy storage buffer, able to be ‘trickle charged’ during a lower power ACDC conversion process, and then provide a boosted charging output to EV 200 during a second higher power DCDC conversion process. The trade-off for operating in this mode is that in a boost conversion the output contains discontinuous currents, and in a buck conversion the input contains discontinuous currents. This requires further filtering to meet the criteria of voltage and current ripple, EMC, EMI, and the like. If the drive switches are interleaved, this can allow for reduced ripple currents, thereby reducing the need for filtering. If ESS 104 is integrated in to charging station 500, the impedance of the link between converter 100 and ESS 104 can be controlled or specified, and therefore the system can be designed to allow for some acceptable ripple current to minimise filtering requirements. When operating in boost mode from ESS 104 to EV 200, the length of cable and impedance of EV 200 is not easily controlled, and therefore extra filtering effort may need to be deployed. In parallel buck or boost modes, discontinuous or ripple currents may exist at EV interface 101 or DC interface 102 when capacitor 117 is unable to provide all of the ripple current, and therefore special consideration to the design of charging station 500 and coupling requirements should be taken to ensure the charger operate within the limits of imposed standards. Therefore, when operating switches in parallel, the operational modes of buck charging of EV 200 from ESS 104 or boost charging ESS 104 from EV 200 may be used, where imposed discontinuous currents can be limited to the specified DC bus side connected to EV 104.

In the illustrated embodiment, converter 100 includes optional capacitor 118 disposed on the output to EV coupler 101 to provide further filtering to EV 200. To avoid a potentially hazardous voltage able to be present at EV coupler 101 when charging station 500 is not in use, capacitor 118 is disposed across switching mechanism 150 such that switch 152 can disconnect at least one pole of capacitor 118 from EV coupler 101, whilst enabling capacitor 118 to be coupled to the output 101 when either switch 151 or 153, and 152 is engaged. This means capacitor is coupled to provide extra filtering of the output or input of EV coupler output 101 in all modes where EV coupler 101 is connected to receive or supply power. In some embodiments, a similar capacitor exists disposed across switching mechanism 120 to accommodate filtering of the power flow through DC interface 102. In other embodiments, capacitor 118 is not employed.

In a mode of operation where charging station 500 is to charge EV 200 of a higher voltage from ESS 104 of a lower voltage, controller 300 may use converter 100 as a boost converter while maintaining the input and output filtering components of inductor 161 and 163. In this mode, controller 300 closes switches 122,123, 152, 153 and optionally 141, and opens switches 121,151,130 and optionally 170. During this operational mode, controller 300 may choose to keep switch 116 turned on, and only provide PWM control to switch 112 (and/or 114 if switch 141 is closed) to regulate the boost charging voltage or current. In this way, controller 300 may reduce switching losses when compared with a sequential boost-buck conversion.

Controller 300 is therefore able to control converter 100 in DC to DC mode such that EV 200 always receives a filtered output, regardless of the voltage differential between ESS 104 and EV 200.

In AC to DC, or DC to AC modes, the controller 300 selectively engages switching mechanisms 130 and 170, and selectively disengages switches 123, 153, 141 and 142. Controller 300 then directs the power flow by connecting drive 110 to EV coupler via switching mechanism 150 (151, and 152 only), or DC coupler via switching mechanism 120 (121, and 122 only).

In this embodiment, filter 107 is a delta connected filter, but in other embodiments filter 107 is a star connected capacitor network where the star point can be selectively connected to the common negative rail in DC to DC mode via switch 142 (not shown). In this way, controller 300 can close either switch 131 or 133 to couple at least one capacitor of filter 107 to the DC interface 102 or EV interface 101 respectively.

In the illustrated embodiment controller 300 can operate drive 110 and switching mechanisms to achieve a DC to DC conversion of buck, boost, or boost-buck.

The boost-buck DC to DC conversion may provide a conversion with no discontinuous currents at the input or output. For example, when charging EV 200 at EV coupler 101 from storage device 104 at DC coupler 102, at a power level enabling continuous conduction mode (CCM) of inductors 161, 162, and/or 163, no discontinuous currents are imposed on DC storage device 104, or EV 200.

In figures with switches 141 and 142; inductors 161, 162, and 163 can be selectively coupled using switches 141 and 142, but in other embodiments, either or both switches do not exist. In other embodiments a further switch 143 is employed to couple inductor 161 and inductor 163, instead of, or in addition to, switches 141 and/or 142.

In the proposed embodiment, DC currents may be injected into the star point of inductors 161, 162, and/or 163 during DC to DC operational modes between DC interfaces 101 and 102. In some embodiments inductors 161, 162, and 163 have no mutual magnetic coupling, or employ a special configuration able to accept zero sequence currents. In some embodiments, a further coupled inductor set/sine filter 165 [not shown] is employed between filter 107 and transformer 106 to create an LCL filter, or where the transformer is removed, between filter 107 and switching mechanism 170.

In this embodiment, switch 170 is able to disconnect the transformer 106 from AC grid interface 103 during idle periods, or during DC to DC conversion, to reduce the idle power consumption of charging station 500. In some embodiments with switching mechanism 170, switching mechanism 130 is not employed, and vice versa. However, if switching mechanism 130 is not employed in the embodiment otherwise illustrated in FIG. 4A, the boost-buck operational mode is prohibited due to the star point connection of the transformer 106.

In another embodiment or version of the disclosure, switch 120 (or switch 153) connects a pole of the DC input 102 (or DC input 101) to the midpoint of the half bridge created by drive switches 111 and 112 (or any other midpoint of drive circuits). In an embodiment with the positive DC pole of 102 connected to the midpoint between switches 111 and 112 via switch 123, controller 300 is able to perform a boost conversion from DC input 102 to DC input 101 by closing switches 121,123 141, 142, 151, 152, and opening switches 130, and supply pulse width modulation to boost switches 114, and 115. In this case, the inductance of inductor 161 acts in series with the inductance of inductor 162 and 163 in parallel, and the boost current flows through the freewheeling diodes of switches 113 and 116. In this case, no zero sequence currents are formed in the three-phase system, and therefore inductors 161, 162, and 163 can be mutually coupled, such as a sine filter structure. In another embodiment, controller 300 operates with switches 142 and 151 open, and switch 153 closed, and performs a boost-buck operation using boost switch 114, and buck switch 116, to create a charging current from DC input 102 to DC input 101. This same alternative configuration of disclosure may be applied to any of the other disclosures and figures in this specification.

FIG. 4B is a schematic of a circuit diagram subset of FIG. 4A for another multimodal DCDC converter 100 that may be applied or configured to the electric vehicle charging station 500. This embodiment is a subset version of FIG. 4A consisting of a multimodal converter for different DC to DC configurations between DC input 101 (which is typically connected to EV200 for charging station 500), and another DC source (which in this embodiment is illustrated as battery storage 104). Therefore, the DC to DC operational modes of FIG. 4A also may apply to this embodiment. In this embodiment, converter 100 is able to act as a boost converter, buck converter, or boost-buck converter depending on the switch states of 120, 140 and 150.

In operational modes when buck mode is chosen to charge a DC source at DC input 101 (exemplified as EV 200 from FIG. 1) from a DC source at DC input 102 (illustrated as ESS 104), controller 100 may close switches 121, 122, 141, 142, 152 and 153, open switch 123 and 151, and operate the upper switches in drive 110 (illustrated as MOSFETs 111,113,116) to regulate a voltage or current.

In operational modes when boost mode is chosen to charge a DC source at DC input 101 (exemplified as EV 200 from FIG. 1) from a DC source at DC input 102 (illustrated as ESS 104), controller 100 may close switches 122, 123, 141, 142, 151 and 152, open switch 121 and 153, and operate the lower switches in drive 110 (illustrated as MOSFETs 112,114,115) to regulate a voltage or current.

In operational modes when boost-buck mode is chosen to charge a DC source at DC input 101 (exemplified as EV 200 from FIG. 1) from a DC source at DC input 102 (illustrated as ESS 104), controller 100 may close switches 122, 123, 152 and 153, open switch 121, 153, and 141 and/or 142. Controller 100 then operates the lower switch 112 of drive 110 to regulate a boost voltage or current on to capacitor 117 and/or 118, and operates the upper switch 116 of drive 110 to regulate a buck voltage or current to the output at DC 101. Further, the switching leg of 113 and 114 may also be utilised, for example, where switch 114 is used as part of the boost sequence (for example, interleaved with switch 112) when switch 141 is closed and switch 142 is open, or alternatively, switch 113 is used as part of the buck sequence (for example, interleaved with switch 116) when switch 142 is closed and switch 141 is open.

The converter 100 can be used to buck, boost, or boost-buck from DC input 101 to 102 in bidirectional mode.

Embodiments which allow for boost-buck or buck-boost DC to DC conversions may allow seamless transition between buck and boost modes and therefore may be advantageous over configurations which allow only boost or buck configurations. For example, when charging a battery 200 at DC input 101 from a battery 104 of similar configuration at DC input 102; battery 104 may start off at a higher state-of-charge (SOC) and thus at a higher voltage than battery 200, thereby initially requiring buck mode operation (including boost-buck or buck-boost) to charge battery 200. As battery 104 SOC is reduced and battery 200's SOC increases throughout the charge event, at some point the voltage of battery 104 (including voltage sag) may fall below the voltage of battery 200 and the conversion will need to swap to boost mode (including boost-buck or buck-boost) to continue the charge. If the converter is limited to either buck or boost mode configurations only, there is the potential that transition will not be as effective without further intervention, especially if the voltage sag is significant and the voltage of battery 104 again rises above battery 200 once the charging load is removed before the converter can swap configurations from buck to boost mode.

Converter 100 may also include further filtering between switching mechanism 120 and Dc input 102, and/or between switching mechanism 150 and DC input 101. Such filtering may include capacitors, inductors, EMI filter, or the like.

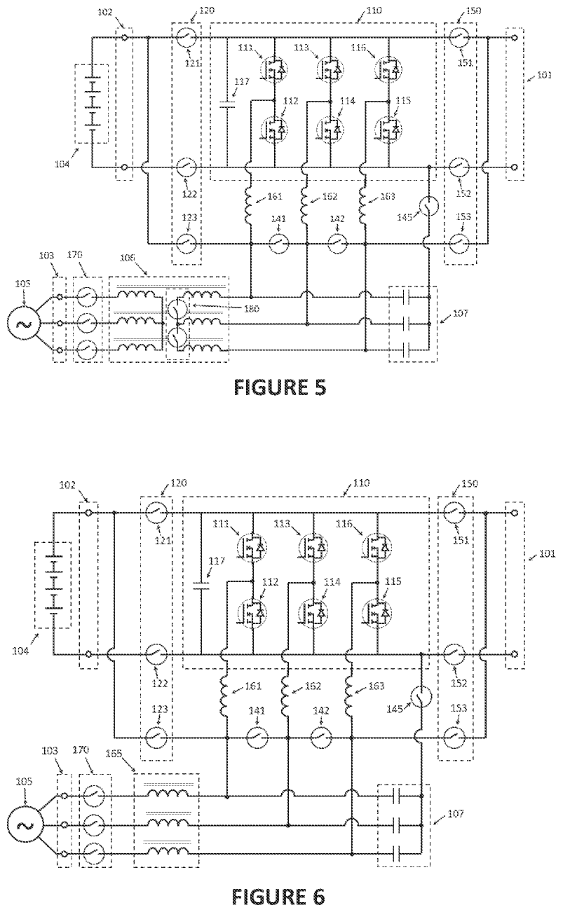

FIG. 5 is an alternative multimode converter to FIG. 4A for EV charging station 500. In this embodiment, switches 130 are removed, and filter 107 is illustrated as a wye connected capacitor network, able to be selectively connected to the common negative DC bus of drive 110 via switch 145. Transformer 106 has a star-point disconnection switching mechanism 180 which enables the star-point of the transformer to be selectively disengaged during some operational modes. For example, switch 180 enables the use of boost-buck DC to DC operational modes without the requirement of switching mechanism 130.

In AC-DC mode, controller 300 engages switching mechanism 180, along with switching mechanism 170, and 120 or 150 (but not 123 or 153), to perform a boost rectification active front end conversion as previously described.

When operating in DC-DC mode, controller 300 disengages switching mechanisms 170 and 180 and apply the switching states of 120, 141, 142, 150 and drive 110 as aforementioned in previous figure descriptions to achieve the desired DCDC conversion type between ESS 104 and EV 200 (buck, boost, boost-buck, bidirectional buck, bidirectional boost, or bidirectional boost-buck).

The capacitors of filter 107 may be used a part of the AC filter with switch 145 open, and to filter both the DC input and output during DC to DC mode with switch 145 closed. That is, during a DC to DC conversion from ESS 104 to EV 200, controller 300 may close switches 122,123, 141 or 142, 145, 152 and 153, and open switches 121, 151, 170, and 180. In this way, drive switch(es) 112 (and/or 114 if switch 141 is closed) represent the boost switch(es), and drive switches 116 (and/or 113 if switch 142 is closed) represent the buck switch(es). Capacitors in the filter network 107 provide filtering of the input current/voltage at the input to inductor 161 (and/or 162), and output filtering of the input current/voltage at the output of inductor 163 (and/or 162).

In some DC to DC boost-buck operational modes, controller 300 controls either the buck switch(es) in 100% duty cycle, or the boost switch(es) in 0% duty cycle (and optionally the top switches of the same boost phase leg to 100% duty cycle), to reduce switching losses.

In a further operational mode, controller 300 may act converter 100 in parallel buck or parallel boost modes with switch 141 and 142 closed. In this mode, filter capacitor 107 with switch 145 closed provides filtering of the input or output using all three capacitors in parallel (for a wye-connected filter).

In another embodiment, switch 119 is also implemented to enable different operational modes and characteristics of DC to DC operation, similar to the usage in FIG. 2.

In other embodiments, switch 145 is not employed, and capacitors of filter circuit 107 provide a circuit of two capacitors in series with floating midpoint between EV interface 101 and DC interface 102.

In another embodiment, switches 180 are not employed, and the converter is unable to operate in boost-buck mode. In such an embodiment, controller 300 operates converter 100 as either a boost or buck converter, where capacitors of filter 107 act to buffer discontinuous currents at the star point of the inductor network of 161, 162, and/or 163 for either the buck or boost conversion. In such embodiments, capacitor 118 may be employed.

In another embodiment, AC disconnect switching mechanism 170 is not employed, and AC source 105 is permanently connected to transformer 106, even when operating in DCDC modes. That is, switching mechanism 170 is not required for the disclosure.

In other embodiments, capacitor 118 (or 117) is comprised of two capacitors in series 118a and 118b, and the star point of the wye capacitor network filter 107 is instead connected via switch 142 to the mid-point of capacitor 118a and 118b.

In other embodiments, switches 141 and 142 are not present, and switches 123 and/or 153 instead connect the DC couplers to the star point of the transformer. In such embodiments, the filter 107 may be disconnected during such operation.

FIG. 6 is a schematic of a circuit diagram of another multimodal converter 100 that may be applied or configured to the electric vehicle charging station 500 of FIG. 1. In this embodiment EV charging station 500 is a mobile charging station, and has storage device 104 integrated into the station. In this and some other applications it has been determined there is no need for galvanic isolation, and therefore the transformer 106 has been replaced with a further series inductor network 165. In this embodiment, series inductors 165 is comprised of three mutually coupled inductors. When combined with inductors 161, 162, 163, and filter network 107 this creates an LCL filter for the AC-DC or DC-AC conversions.

In the case where EV 200 is never charged directly from grid 105, switch 152 may be optionally removed.

As the phases of the series inductor network 165 are not electrically connected to each other when disconnected from the AC interface 103 via switch 170, this enables converter 100 to selectively be able to perform a bidirectional buck. boost, or boost-buck conversion in DCDC mode.

In embodiments of charging station 500 where AC power is a disconnect-able power source at interface 103, which is never intended to be connected during the DCDC control mode, switching mechanism 170 may be eliminated from the circuit. Such a use case may be when charging station 500 is a mobile charger where there is no access to an AC source at the location of a DCDC charge event.

Switching mechanism 170 may also be eliminated in jurisdictions or applications where galvanic isolation is not required.

The operation of converter 100 and controller 300 perform in a similar manner to aforementioned embodiments for ACDC, DCAC and bidirectional DCDC operational modes. In particular, FIG. 6 is able to operate in DC to DC modes in the same manner as FIG. 5 with switching mechanism 180 open.

In other embodiments, inductor set 165 includes a further set of switches 180 [not shown] to create a star point between the inductor set 165 and AC disconnect switches 170 (and/or AC interface 103).

In other embodiments, the further filtering of inductor set 165 is not required, and it is therefore not employed.

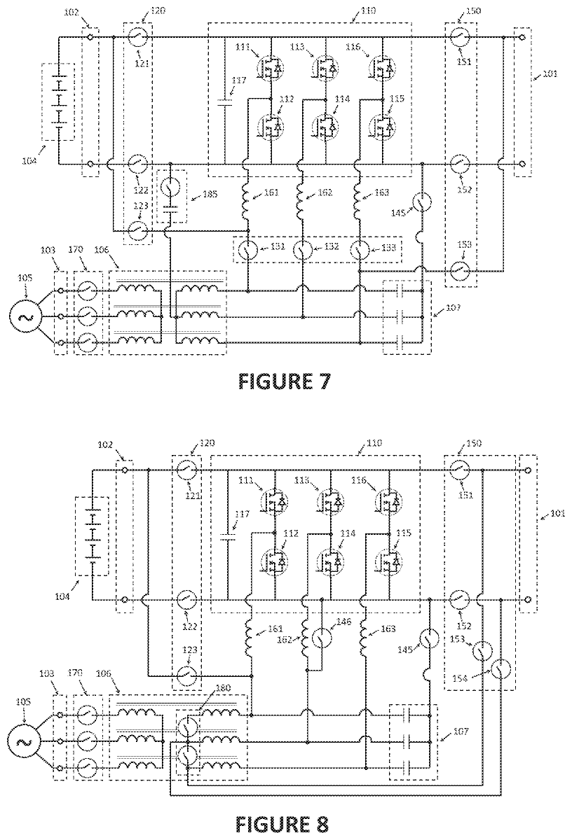

FIG. 7 is a schematic of a circuit diagram of another multimodal converter 100 that may be applied or configured to the electric vehicle charging station 500 of FIG. 1. In the illustrated embodiment, switch 153 of switching mechanism 150 interfaces between the AC disconnect switching mechanism of 130 (particularly switch 133) and AC interface 103, thereby enabling new modes of operations to occur with increased filtering. Furthermore, converter 100 is able to selectively connect a capacitor between the negative DC bus power rail of drive 110 and the star point of transformer 106 (or similarly the star-point of inductor set 165 when using switches 180 [not shown]) using switch 185. In this embodiment, converter 100 is able to further filter the DC output to EV coupler 101 during a DC to DC conversion by using the secondary windings of transformer 106 (and/or inductor set 165). For example, with switches 122, 123, 132, 145, 152, 153, and 185 closed, and 121, 131, 133, 151, and 170 open, controller 300 is able to perform a boost-buck conversion from the ESS 104 to EV 200 using drive switches 112 as a boost switch, and drive switch 113 as a buck switch. In such a conversion, the output current flows through inductor 162, through two of the mutual windings of transformer 106 with capacitor 185 in between (T filter), and out switch 153 to EV interface 101. Filter 107 is able to provide filtering capacitance before and after the T filter by the use of switch 145. Furthermore, closing switch 145 connects the third mutually coupled leg of the transformer with a DC blocking capacitor from filter 107, thereby creating elements of a coupled linear two-port filter. In other embodiments, switch 180 is employed to selectively disconnect the third transformer phase from the star point of transformer 106 (or inductor set 165). As would be appreciated by those skilled in the art, each real-world/practical implementation and associated requirements will differ according to each application, and therefore further damping or tuning elements may be added to the filter sections after specific characteristics and core component values are selected.

Operational modes similar to previous embodiments without the added filtering component of the secondary winding of transformer 106 are able to occur by opening switch 132 and closing switch 133 during DC to DC modes.

Although in the illustrated embodiments, transformer 106 is shown as a wye-wye connected transformer, in other embodiments other connection configurations are possible.

In another embodiment, switch 123 interfaces to between the switching mechanism 131 and AC interface 103, and switch 153 interfaces between the switch 133 and drive 110. This alternative arrangement provides the further filtering on the side of the DC interface 102.

FIG. 8 is a schematic of a circuit diagram of another multimodal converter 100 that may be applied or configured to the electric vehicle charging station 500 of FIG. 1. In the illustrated embodiment, transformer 106 employs star-point disconnection switches 180, a reconfigured switch 153 to selectively connect the positive DC rail of interface 101 to a phase of transformer 106 (or inductor set 165), and a further switch 154 of switching mechanism 150 to selectively connect the negative DC rail of interface 101 to another phase of transformer 106 (or inductor set 165). This configuration enables the secondary winding of transformer 106, or the phases of inductor set 165, to be used as a common mode filter for the output of interface 101. An optional switch 146 is also illustrated to shunt inductor 162 and the associated phase capacitor of filter 107, to provide a low impedance path to ground.

In one example DC to DC operational mode from ESS 104 to EV 200, controller closes switches 122,123,145,146,153, and 154, and opens switches 121,151,152, 170, and 180. Controller 300 then uses drive switch 112 to perform a boost operation onto capacitor 117, and drive switch 116 as a buck charge through inductor phase winding 163 and associated transformer 106 secondary winding, and out switch 153 to EV interface 101. The corresponding return path from EV interface 101 returns through switch 154 and the associated coupled transformer winding to ground through switch 146. Alternatively, switch 146 is left open, or not employed, and the return path flows through inductor 162 and to ground through drive switch 114 held on or switched by controller 300.

In another mode of operation, the secondary winding of transformer 106 can act as a differential mode filter by operating switching mechanism 150 with switch 152 and 153 on, and switches 151 and 154 off.

In an alternative mode of operation, controller 300 can bypass the common mode filter formed by transformer 180 by closing switches 151 and 152 and opening switches 153 and 154.

If the bypass functionality is not required in any operational mode (for example, EV 200 is never charged directly from grid 105), switches 151 and 152 are not required and are optionally employed or eliminated.

In other embodiments, switch 131 may be optionally employed to eliminate the effect of mutual coupling of ripple on the third phase of the transformer. In some embodiments optional switch 131 may be located in the previous disclosed location, or in a reconfigured location between the transformer winding and connection point of the switch 132 and filter 107 to enable the filter capacitor to still function for filtering input at DC interface 102 with switch 122, 123, and 145 closed.

Although descriptions are focused on the charging of EV 200 from ESS 104, the converter 100 operates in the same spirit bidirectionally. In the same way, ESS 104 may be located at DC coupler 101, and EV 200 may be coupled at DC interface 102 for any of the embodiments. Alternatively, switching mechanism 120 may interface to a secondary winding of the transformer 106 instead, or optionally in addition to switch 150.

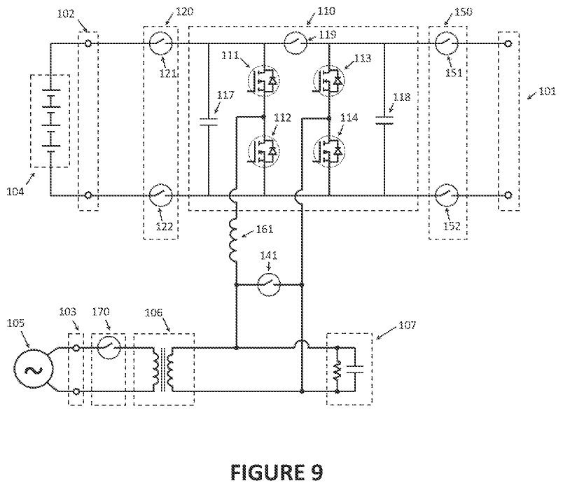

FIG. 9 is a single-phase variation of FIG. 2 for a single-phase multimodal converter to be applied in charging station 500. In this embodiment, the modes operate in the same manner as FIG. 2, and the system can operate in AC to DC, DC to AC, or DC to DC. In DC to DC mode, bidirectional buck, boost, or buck-boost modes are possible.

In other single-phase embodiments, converter 100 employs switches 123 and/or 152 such that the system is able to provide buck or boost DC to DC modes with switches in parallel for increased power capability. In such embodiments, switch 119 may be eliminated.

In other single-phase embodiments, filter 107 is not employed, or is of a different type.

In other single-phase embodiments, a further inductor 162 is employed on the phase connecting to the drive circuit comprising of switches 113 and 114.

In other single-phase embodiments, transformer 106 is not employed, and AC disconnect switching mechanism 170 is double pole.

In embodiments where filter 107 is not employed, and transformer 106 is employed, then switch 141 may be eliminated, with the DC currents of the DCDC mode making use of both the inductance of inductor 161 and the secondary winding of transformer 106.

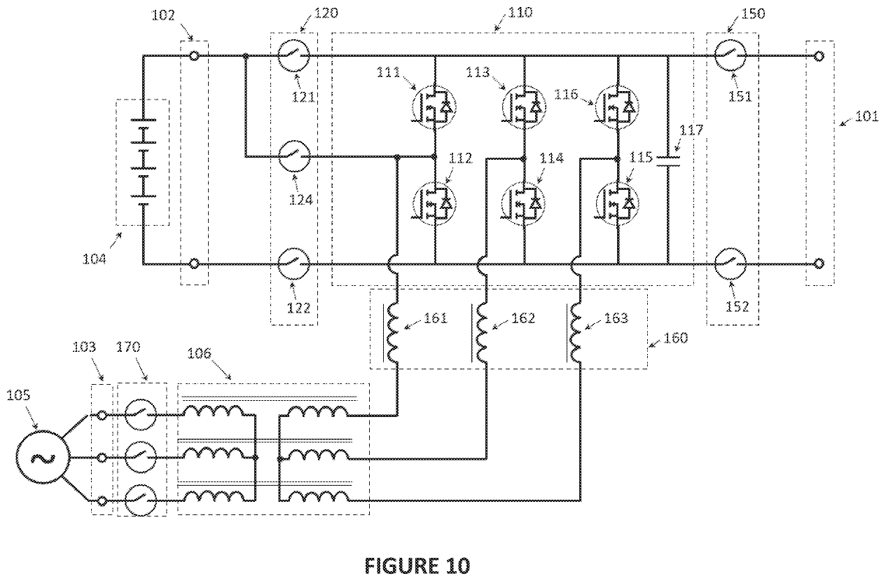

FIG. 10 is a schematic diagram of another multimodal converter 100 capable of buck or boost DCDC mode as well as ACDC mode that may be applied or configured to the electric vehicle charging station 500 of FIG. 1. This embodiment may operate similarly to that of previous figures including switch 123 of switching mechanism 120, however, in this embodiment includes a switch 124 within switching mechanism 120 to selectively connect one of the DC input terminals to one of the mid-points of a half-bridge contained within converter 110 (exemplified by the mid-point between MOSFETs 111 and 112 in the illustrated embodiment). Where applicable, features and capabilities of other embodiments detailed in this application may apply. Converter 100 may be controlled by controller 300 (as illustrated in FIG. 1) to selectively engage different modes and regulate the voltage or current or other parameters of the conversion or intended operation. In this embodiment, converter 100 may act in AC to DC mode by closing switches 170, actively controlling the power switches of converter 110 (exemplified in this embodiment as MOSFETs 111-116), and either routing power to a DC source at DC input 102 (in this embodiment exemplified as ESS 104) by closing switches 121 and 122 of switching mechanism 120, or routing power to a DC source at DC input 101 (in this embodiment represented by EV 200 as illustrated in FIG. 1) by closing switches 151 and 152 in switching mechanism 150. Therefore, by converter 100 acting in AC to DC conversion mode, AC grid 105 can be used to charge either ESS 104 or EV 200, or return power to grid 105 in bidirectional mode.

Converter 100 is also able to act in DC to DC mode between the DC inputs 102 and 101 by opening switches 170, and closing switches 122 and 124 of switching mechanism 120, and closing switches 151 and 152 of switching mechanism 150. In this way, converter 100 is able to actively control the lower switches of the half-bridges which are not connected to the DC input terminal by switch 124 (in the illustrated embodiment exemplified by MOSFETs 114 and 115) to regulate a DC to DC boost conversion between the sources at DC input 102 to the source at DC input 101 (in this embodiment represented by ESS 104 and EV 200 respectively). Similarly, converter 100 can operate in DC to DC buck mode in the opposing direction by actively operating the upper switches of the half-bridges not connected to a DC input by switch 124 (in this embodiment exemplified by MOSFETs 113 and 116). Therefore, converter 100 is able to bidirectionally operate to regulate a boost current or voltage from DC input 102 to DC input 101, or a buck current or voltage from DC input 101 to DC input 102.

In the illustrated embodiment converter 100 uses an attached sine filter 160 and/or any inductance of transformer 106, as buck or boost inductance for the conversion process. The present embodiment has a distinct aspect with switch 123 or 153 in that there are no zero-sequence currents imposed on inductor set 160 and/or transformer 106 in DC to DC modes. That is, the sum of the currents of inductors 161, 162 and 163 equal zero, and therefore allows the inductors to be magnetically coupled without causing saturation or unwanted effects. This allows the inductor set to form (at least in part) a sine filter, which may improve the efficacy of converter 100 when operating in AC to DC and DC to AC modes.

In other embodiments or versions, a further switching mechanism 140 (comprising of switches 141, 142, and/or 143) may be employed to shunt one or more of the electrical phases between inductor set 160 and transformer 1106 as exemplified in previous embodiments. In this way, switching mechanism 140 can be used to bypass current flow in transformer 106 during DC to DC conversion modes.

In another embodiment, EV 200 may be located at DC input 102 and ESS (or another DC source) may be located at DC input 101, such that converter 100 can act to perform a DC to DC buck conversion from ESS 104 to EV 200, or a DC to DC boost conversion from EV 200 to ESS 104.

In a further embodiment converter 100 may employ a further switch 154 to connect a terminal of DC input 101 to a mid-point of another half bridge within converter 100 (for example, the mid-point between MOSFETs 115 and 116 connected to inductor 163) in addition to switch 124. Switch 154 may then be used instead of switches 124 and 151 (with switch 121, 122, 152 and 154 closed) to provide DC to DC buck operation from DC input 102 to DC input 101, or bidirectionally a DC to DC boost conversion from DC input 101 to DC input 102. In this way, converter 100 may selectively choose to engage switch 124 or switch 154 along with the corresponding switches to provide either buck or boost mode bidirectionally between the two illustrated DC inputs. Such an embodiment may be advantageous in applications where the voltage relationship between the DC input 101 and DC input 102 cannot be ensured.

In another embodiment controller 100 includes a filter 107. Filter 107 may be connected and consist of elements as described and exemplified in previous figures. In some embodiments, filter 107 may include further switching mechanisms to isolate some or all filter components to eliminate or enhance their effect during selective modes of operation. In some embodiments fitted with further switching mechanism 140, one or more of the switches included within switching mechanism 140 may be used to shunt elements of filter 107 such that their effect is minimised in certain DC to DC operational modes.

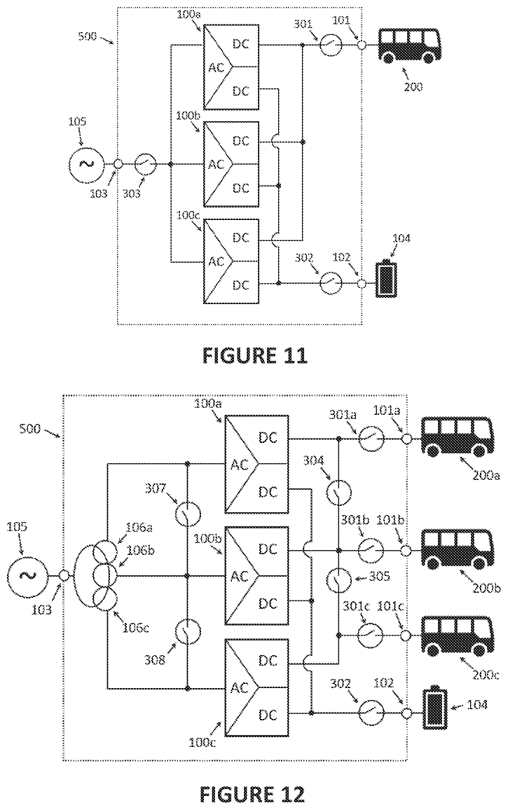

FIG. 11 is a single line diagram overview of a charging station 500 including multiple multimode converters 100. In this embodiment, three converters 100a, 100b, and 100c are shown, but in other embodiments, another configuration of one or more converters are present.

In this embodiment, converters 100a, 100b, and 100c can act together in parallel individually to convert AC to DC, DC to AC, or DC to DC, or any combination of modes therefore between the three sources/sinks.

Controller 300 [not shown] is a supervisory controller for each of the converters 100a, 100b, and 100c, and interfaces with other external sources such as the grid 105, electric vehicle 200, and battery storage system 104, to determine the best mode of operation. Controller 300 is also connected to the cloud, and can gather data such as electricity spot pricing, ancillary energy market opportunities, demand response events, weather forecasts, energy forecasts, charger backend systems, fleet management systems, and the like. Controller 300 is therefore able to optimize each conversion, and plan peak shaving, load shifting, and other routines, based on a forecasted schedule.

Switches 301, 302, and 303 enable controller 300 to selectively connect or disconnect EV 200, storage 104, or AC grid 105 respectively from all converters. Controller 300 is also able to independently selectively disconnect each converter from the different sources via any aforementioned individual switching mechanisms 120, 150, 130 or 170 (not shown, but exemplarily shown in previous figures of converter 100).

For example, in one mode of operation, converters 100a and 100b act in ACDC active rectification mode to charge EV 200 from grid 105, whilst converter 100c performs an ACDC rectification to charge storage device 104.

In another example mode of operation, converters 100a and 100b act in ACDC active rectification mode to charge EV 200 from grid 105, whilst converter 100c performs an DCDC conversion to additionally charge EV 200 from storage 104.

In some embodiments, controller 300 is able to control and synchronise switching of the drive switches (111,112,113,114,115,116) of one or more converters such that switching can be optimized, including interleaving or consecutive conversions, to reduce input or output ripple, improve efficiency, harmonic distortion, EMI, reduce stress on components, spread heat, balance cycle life, or to improve any other measure of efficacy of the conversion.

In some embodiments, a common filter is employed on any of the input or outputs to further filter the outputs or inputs of converters 100a, 100b, and/or 100c.

For the purpose of an example, it is assumed that the components of each converter phase are rated to 300A RMS, and has a maximum DC bus voltage of 1000 VDC. It is also assumed the 3-phase AC voltage from the grid is stepped either up or down through transformer 106 to achieve a voltage of 250 VAC at the secondary winding. This means, the converter is only able to regulate a DC voltage or current in active front end AC to DC rectification mode between 354 VDC and 1000 VDC. The nominal DC voltage of storage 104 is assumed to be 800 VDC. Therefore, we can assume the maximum input power of the AC conversion will be limited to roughly 129 kVA, and the maximum input power of the DCDC conversion will be 240 kW when in buck mode using a single phase, and may be up to 720 kW when operating all three phases in parallel (in embodiments which allow this), assuming the balance of system components are adequately rated.

Using the above example figures, the maximum AC grid draw occurs with all converters 100a, 100b, and 100c acting in active ACDC rectification mode in parallel, drawing up to 387 kVA from the grid. The combined input power of all converters acting in DCDC mode could be in excess of 2 MW, assuming storage 104 and EV 200, and the balance of system are capable of such power transfer.

In an example combination operational mode, two converters perform ACDC for 248 kVA AC draw, added to a single converter acting in DCDC mode up to 240 kW, for a combined input power of 488 kVA. The output power to the vehicle could roughly be 450 kW depending on efficiency and power factor, with roughly half the power from the AC grid, and half from the battery, thereby providing peak shaving.

In another example, one converter could perform an AC to DC, with the other two performing DC to DC.

In another example, two converters charge the vehicle 200, whilst the other recharges the storage 104.

In operational modes when all converters are acting in DCDC mode, then no power is drawn from the AC grid. The system therefore is capable of operating during blackout and brownout events, and participating in demand response events.

In some operational modes, converters perform conversions serially. In one such example, vehicle 200 requests a charge of 200 A, and has an onboard voltage of 200 VDC which is below the active rectification voltage minimum of 354 VDC provided in the previous example. In this example, supervisory controller 300 controls converter 100a to perform a constant voltage AC to DC rectification to the secondary DC bus 102a of converter 100a of 400 VDC (with switch 302 open), and controls converter 100b to perform a constant current step-down DCDC to conversion from 102b (400V) to 101b (200V) with output of 200 A. In this way, charging station 500 is able to regulate a charge to an EV form grid 105 with a voltage lower than the traditional ACDC rectification process by performing an ACDC then DCDC conversion in series.

In the above example, controller 300 can optionally close switch 302 and use storage 104 as an intermediary buffer between the rectification conversion and the DC to DC conversion to buffer energy and/or reduce switching ripple. In the proposed example, this would require the rectification output of 100a to boost to 800 VDC, and then the secondary conversion of converter 100b to perform a wider 800V to 200V step down DC to DC conversion.

In light of the capability to provide a regulated voltage output lower than the rectified AC voltage, the AC grid input voltage can be maximised to reflect the lowest state of charge DC voltage of the attached storage 104. This increases the AC rectification power output capability as each converter can transfer more power for the given current limitation, whilst maintaining compatibility for vehicles with traction voltages below that of the minimum voltage of storage 104.

In some embodiments where individual converters are fed by a separate transformers or separate secondary windings, the AC input voltages may be selected to be different for different converters to provide a wider and more versatile output voltage range of rectification natively, without requiring series conversions.

In embodiments with a single EV coupler 101, each converter need not have its own isolation transformer 106, and a single isolation transformer is added externally at the common AC input 103, or internally before or after switch 303. In this case, the size and cost of each converter may be significantly reduced. The isolation transformer 106 may have multiple secondary windings to feed each converter with a galvanically isolated AC input.

In some embodiments, not all converters are fitted with a transformer or galvanic isolation for charging EV 200 directly from grid 105.

In some embodiments, no galvanic isolation from grid 105 is required, and therefore all transformers can be eliminated.

In other embodiments where each converter has an isolation transformer, multiple EV coupler outputs like 101 are possible, with up to one per converter able to be used simultaneously whilst providing galvanic isolation to each vehicle.

In some embodiments, a single transformer with multiple secondary windings is used to each feed one or more of the converters in charging station 500.

Reference is now made to FIG. 12 consisting of a charging station 500 with three EV coupler interfaces 101a, 101b, and 101c supplied by three multimodal converters 100a, 100b, and 100c. In the illustrated embodiment, each EV coupler interface 101a, 101b, and 101c can be connected or disconnected by a double pole switching mechanism 301a, 301b, and 301c respectively. Using switches 304 and 305 (and optionally 306 [not shown] connecting converter DC outputs of 100a to 100c), the DC output power of each converter can be decoupled to charge separate vehicles, or combined to charge a single vehicle. For example, with switch 304 closed and 305 open; the outputs of converter 100a and 100b can be used to charge vehicle 200a or 200b by closing switch 301a or 301b respectively; whereas the output of converter 100c is free to charge vehicle 200c at a separate independent voltage.

Galvanic isolation between the converters is able to be achieved in AC to DC mode by the use of transformer 106 with common primary winding, and three galvanically isolated secondary windings 106a, 106b, and 106c.

In the illustrated embodiment it is assumed each secondary winding is rated to one third the power of the total transformer, and therefore secondary windings can be bridged using switch 307 and/or 308 (and/or 309 [not shown] connecting winding 106a and 106c) to increase the total AC load current able to be drawn by a single converter. This enables a single converter to perform an AC to DC rectification at a higher power, whilst leaving the other converters available to perform other conversions.

In another embodiment, switches 307 and 308 (and 309 not shown), are not employed, and the three-phase inputs to each of the converters are electrically independent from each other, but may have some mutual magnetic coupling via the three secondary windings 106a, 106b, and 106c.

In another embodiment, each secondary winding also includes a set of disconnection switches 303a, 303b, and 303c to selectively disconnect the output of each secondary winding from its respective converter, thereby enabling AC to be transferred between converters independently of the grid.

In another embodiment, a grid disconnects switching mechanism 303 is employed on the primary winding of transformer 106 to enable anti-islanding operation.

In another embodiment, each converter 100a, 100b, and 100c, has its own transformer 106a, 106b, and 106c respectively.

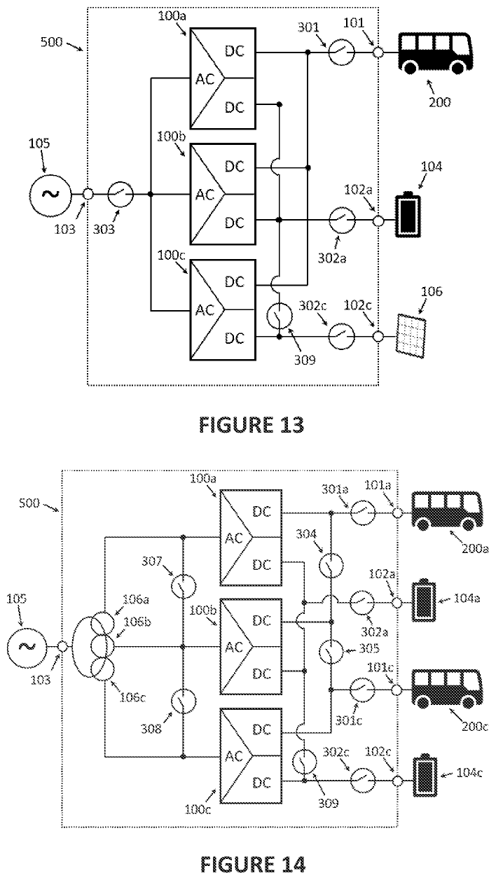

Reference is now made to FIG. 13 consisting of an EV charging station 500 for electric vehicle 200, with battery buffer 104, and auxiliary DC power source of PV solar array 106. In this embodiment, when solar irradiance is high (e.g. the sun is shining) and vehicle 200 is requesting a charge, converter 100c may perform a DC to DC conversion with maximum power point tracking (MPPT) from array 106 to vehicle 200 with switch 309 open, and switches 301 and 302c closed. If power is insufficient to satisfy vehicle 200, then converter 100a and/or converter 100b may also provide charging power derived from either storage 104 or grid 105. If solar power is excessive, either converter 100a or 100b may draw on the DC current supplied by converter 100c and invert the excess back to grid 105. Alternatively, converter 100c can use the solar energy to perform a DC to AC conversion, where of the AC current is drawn by either converter 100a or 100b to perform an AC to DC rectification to charge vehicle 200, and the remained is exported to grid 105. If vehicle 200 is not present at EV coupler 101, or is not requesting to be charged, then converter 100C can perform a DC to AC conversion to export all of the solar power to grid 105.

When solar irradiance is low (e.g. the sun is not shining), converter 100c may be used to charge vehicle 200 directly from AC grid 105, and converters 100a and/or 100b can supplement the power with further AC to DC or DC to DC conversions. Alternatively, converter 100c can perform a DC to DC conversion with switch 309 closed and switch 302c open.

In some embodiments, array 106 is other than a solar panel array.

In some embodiments, storage 104 is made up of multiple isolated modules which can be paralleled to charge a single vehicle 200, or separated to be used to charge multiple vehicles whilst maintaining galvanic isolation from each other.

Reference is now drawn to FIG. 14 where storage 104a is split into two galvanically isolated packs of equal nominal voltage, where 104a is connected to DC interface 102a, and 104c is connected to DC interface 102c.

In the present embodiment, switching mechanism 309 is a double pole switch employed on the DC bus between the DC interface 102 of converter 100b and the DC interface 102 of converter 100c.

In other embodiments, a further double pole switching mechanism 310 is employed on the DC bus between the DC interface 102 of converter 100a and the DC interface 102 of converter 100b. In this way, 100b is able to be galvanically isolated from either or both of 104a and/or 104b using double pole switching mechanisms 309 and/or 310.

Packs 104a and 104c can be combined in parallel into a single pack by closing switches 302a, 302c and 309. In this mode, any of the converters can draw from the combined storage pack 104 to charge either electric vehicle 200a or 200c, or export to grid 105.

Alternatively, switch 309 can be opened, and multimodal converter 100a or 100b can charge vehicle 200a in DC to DC mode from storage 104a, and converter 100c can charge vehicle 200c in DC to DC mode from storage 104c, whilst maintaining galvanic isolation between vehicles 200a and 200c. In the illustrated embodiment, converter 100b can charge either vehicle 200a or 200c from AC grid 105 during this period, however, it is only able to charge 200a in DC to DC conversion mode unless switch 110 is employed.

In the case where 104a and 104c become unbalanced, each can be charged individually by separate converters to obtain the same state of charge. If the packs are required to be bridged prior whilst unbalanced, the lower voltage pack can be increased temporarily via an AC to DC rectification, or via a DC to DC conversion of two converters in series using energy from the higher voltage pack.

In other embodiments, charging station 500 has three DC interfaces for electric vehicles 200a, 200b, and 200c, and three interfaces for DC storage 104a, 104b, and 104c.

Although in FIGS. 11, 12, 13, and 14 show three converters 100a, 100b, and 100c, in other embodiments, charging station 500 has other than three multimodal converter modules. For example, charging station may be implemented with one, two, or four or more converter modules.

Similarly, charging station 500 may have one, two, or three or more EV interfaces, DC storage interfaces, AC interfaces, or other power source or sink interfaces.

In some embodiments, the inclusion of double pole switching mechanisms 301a, 301b, and/or 301c external to converter 100a, 100b, and 100c, eliminate the requirement for converters 100a, 100b, and/or 100c to include some or all elements included in switching mechanisms 150a, 150b, and 150c.

In some embodiments, controller 300 is able to manage one or more multimodal converters 100 to achieve an optimal conversion between the sources and sinks.

In some embodiments, controller 300 is able to communicate with external sources to help identify which operational modes shall be chosen, and for each conversion shall determine the duration and proportion of load drawn from each power source, and the regulation of load delivered to each power sink.

In embodiments with attached storage device 104, controller 300 is able to determine the extent of load shifting and power shaving performed by the storage device.

In embodiments with attached external DC source 106, controller 300 is able to determine when load is able to be drawn from the external source, and regulate the power flow (for example to achieve MPPT) within acceptable limitations.

In some operational modes, controller 300 links the DC bus of the first DC source 101, and the second DC source 102 together using the switching mechanisms 120 and 150, or another switching mechanism. In such cases, controller 300 is able to also control the drive circuits of converter 110 to operate in boost rectification mode to add current or voltage from the AC source to the now common DC link.

For charging station 500 with multiple embodiments of converter 100 which have a limitation of discontinuous currents at high power outputs in some operational modes, controller 300 can operate two or more converters in series to provide continuous filtered currents on both the input and output. That is, controller 300 can operate a sequential boost then buck operation using two or more converters in series.

In embodiments with multiple multimode converters 100, controller 300 can operate conversions in parallel or in series. Parallel operations can be used to increase power or reduce ripple through interleaving. Series operations can be used to widen voltage range, reduce ripple or EMI (for example through a boost then buck conversion), or to transfer energy between DC sources. When operating in series mode, controller 300 need not provide any voltage or current regulation and therefore can simply bridge DC interfaces 101 and 102 to improve efficiency and avoid switching losses.

In embodiments with multiple converters 100 in charging station 500, controller 300 can selectively operate each converter in a chosen mode of ACDC or DCDC to charge vehicle 200. Throughout the charging of vehicle 200, controller 300 may choose to operate converters in different modes dependant on factors including; storage 104 state-of-charge, vehicle 200 state-of-charge, electricity pricing or demand response request of grid 105, solar generation of panels 106, temperature or derating of components, or the like. Controller 300 can communicate with other controllers to determine the required mode or modes of operation.

Electric vehicles generally require different charging power levels as charging events takes place and the vehicle batteries heats and increases in state-of-charge. In some embodiments, the power output to the vehicle coupler 101 per converter 100 may differ between ACDC or DCDC mode depending on a range of factors including differences in input voltages of AC source 105 (including voltage translation ratio of any transformer 106), and input voltage of storage 104. In most embodiments, the minimum voltage of storage 104 exceeds the rectified voltage of the AC input voltage such that converter 100 can regulate a full charge of storage 104 from AC source 105. During a charging event of vehicle 200, controller 300 determines the instantaneous mode of operation of each converter 100 to achieve the optimal method of achieving the requested output voltage or current. In some embodiments, operating converters in DCDC mode is able to “boost” the power capability of charging station 500 beyond the AC grid connection capacity of grid 150, and therefore DCDC mode may be selectively chosen for high-power output. When power output is within the AC grid connection capacity of grid 105, then ACDC modes may be selected to preserve the state-of-charge (SOC) and cycle life of battery 104. For example, at the start of a charge while vehicle 200 state-of-charge and therefore voltage is low, some converters 100 may act in DCDC mode, and some in ACDC to achieve a constant current output. As vehicle 200's SOC and voltage increases for the same desired current, controller 300 may instruct more or all converters 100 to act in DCDC to achieve the highest power-output possible. As the SOC of vehicle 200 increases further or its batteries get to temperature, it may reduce its requested current, and therefore some or all of the converters 100 of charging station 500 may switch back to ACDC mode. As vehicle 200 reaches full charge, it may request a constant voltage, or low current charge, which controller 300 may satisfy using only a portion of converters 100 to charge vehicle 200, whilst using spare converters 100 to recharge storage 104 from grid 105. In embodiments where there is a large power discrepancy between ACDC and DCDC modes, more converters 100 within charging station 500 provides a more modular and flexible output which may be used in the application of the disclosure, with smaller “steps” in power output as converters are swapped between ACDC and DCDC modes.

In embodiments, the drive switches of drive inverter 110 can operate singularly, or in parallel, or interleaved to achieve the desired conversion power, efficiency, or ripple characteristics.

In embodiments employing a boost rectifier topology, the voltages of the DC coupler 102 and/or EV coupler 101, may be of higher value than the rectified voltage equivalent of the AC voltage presented of the AC coupler 103, after any voltage ratio translation performed by transformer 106.

In some embodiments or versions, charging station 500 may charge EV 200 with a wide filtered output voltage and current range.

In some embodiments, the converter 100 is able to act in four quarter optional modes with adequately filtered input and/or output current or voltages.

In some implementations with attached DC source 104 at DC interface 102, the voltage of the DC source has a high nominal voltage, with maximum voltage close to the maximum safe operating DC voltage rating of converter 100.

In some embodiments utilising boost-buck conversions, either through the use of switch 123 and 153, or through operating converters in series (first converter in boost, second in buck), controller 300 may control the conversions such that input and output ripple, and/or EMI, and or filtering requirements, are reduced through the elimination or reduction of discontinuous currents (when operating in continuous conduction mode).

In other embodiments, converter 100 has other than 3 phases, but operates on a similar principal.

Storage device 104 has been illustrated in FIG. 1 and others as a discrete component, however, it will be recognised that this storage device could be integrated as part of the charging station itself for consistent look and feel, control over operational variables (including DC impedance), and optimization of the charging station as a whole.

In other embodiments storage device 104 may be a DC power source, such as a solar panel array, turbine or wind generator with rectifier, other AC source with rectifier, or the like.

In other embodiments, multiple sources or sinks could be present at one or more of the interfaces 101, 102, and/or 103, with further switching mechanisms employed to selectively choose between sources or sinks.

In other embodiments AC grid 105 is another AC source such as a diesel, wind, or turbine generator, or a DC source with inverter such as a solar panel array.

It will be appreciated by those skilled in the art that the embodiments may not be shown as complete embodiments for the sake of simplicity and clarity of illustration. It will be noted that additional safety or regulatory components may be implemented in a real-world implementation which are not core to illustrating the disclosure operation, such as additional switches, fusing, filtering, capacitors, soft-start mechanisms, pre-charge mechanisms, etc.

It will be appreciated by those skilled in the art that the implementations may be adapted to include single-phase topologies, two-phase topologies, poly-phase topologies, 4-wire topologies, any variants including neutral and grounding, filters, 3-level converters, rectifier topologies, and the like.

It will be noted that switches and operational modes shown or described in one embodiment can be applied to another embodiment where not illustrated or described. Not all denominations or combinations of modes and illustrations have been supplied for simplicity and clarity of the document.

It will be noted that reference to interleaving, can represent any strategy of switching two or more switches in a controlled or uncontrolled manner to achieve a result.

It will be appreciated by those skilled in the art, that circuits with equivalent or similar intended operational modes can be constructed by inversely placing switches illustrated on the positive power rail to a negative power rail, and vice versa. For example, switch 119 can be placed on the negative DC power rail of converter 110, or switching mechanisms 123 and/or 153 can be used to connect the inductive load phases to the negative power rail of DC interfaces 102 and 101 respectively.

It will be appreciated by a person skilled in the art that the transformers can be delta-delta, delta-wye, wye-delta, wye-wye, or other configurations.

It will be appreciated to anyone/person skilled in the art that the above disclosures can be applied to other inductive loads. For example, where inductors 161, 162, and 163 comprise the three-phase windings of an electric motor, for example in an electric vehicle. In the example of an electric vehicle 500, storage 104 comprises the onboard traction battery, where in traction mode, controller 300 closes switches 141 and 142 to create a star point and injects AC currents using drive inverter 110 to create torque by drawing upon energy in traction battery 104 at DC interface 102. In charging mode, the electric vehicle accepts a DC voltage from charging station 200 at DC interface 101, and performs a DCDC conversion as described herein the specification to recharge traction battery 104 at DC interface 102. In other modes, the electric vehicle can accept an AC charging current from grid 105 using the inductive phases of traction motor 160 (161, 162, 163) as boost inductors. A transformer may be located onboard the vehicle after AC interface 103, off-board the vehicle, or not present in the circuit. In some embodiments, electric vehicle 500 does not include the AC interface 103, filter 107, transformer 106, and/or AC disconnect switches 170. In most embodiments, the vehicle chassis is grounded during charging operation. In other implementations, electric vehicle 500 has multiple DC sources onboard such as a battery and a capacitor bank where the DCDC mode can transfer power between the two packs. In other embodiments, multi-modal converter system 500 can be applied to any number of other applications or use-cases.

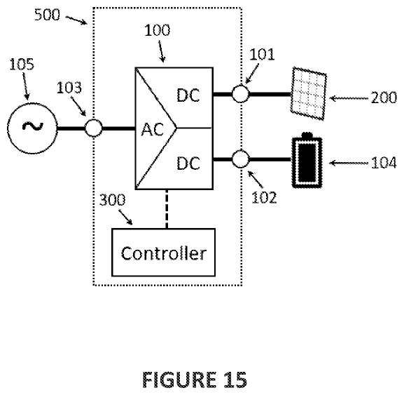

FIG. 15 is a distributed energy resource (DER) 500 deployed as part of a wider network of energy resources attached to grid 105. DER 500 contains one or more multimodal converters 100, a DC power source illustrated as a PV array 200 connected at DC interface 101, and a DC energy storage system (ESS) 104 connected at DC interface 102. In this embodiment, PV array 200 and ESS 104 create a DC micro-grid, able to act independently of the grid. In one mode of operation, solar energy produced by PV array 200 may be selectively stored in ESS 104 via multimodal converter 100 operating in DC to DC buck or boost modes. In another mode, solar energy produced by PV array 200 may be selectively exported to grid 105 via use of multimodal converter 100 acting in DC to AC mode. In some embodiments, multimodal converter employs a maximum power point tracking (MPPT) algorithm to extract the most power out of the solar panels for a given irradiance input. In another mode of operation, ESS 104 can export accumulated energy to grid 105 via converter 100 acting in another DC to AC mode. In a further mode of operation, ESS 104 can be recharged from grid 105 via converter 100 acting in AC to DC mode. In a still further mode of operation, converter 100 can link the DC bus of PV 200 and ESS 104, such that power can be exported to grid 105 from both sources simultaneously by acting converter 100 in DC to AC mode at a higher power than the power supplied by PV 200. In another operational mode with the DC bus linked, PV 200 can export to both sources simultaneously, by converter 100 operating in DC to AC mode at a power level lower than the power provided by PV 200. In a further operational mode with the DC bus linked, ESS 104 can source power from both PV 200 and grid 105 by operating converter 100 in AC to DC mode. That is, in modes when DC bus are linked, controller 300 can control converter 100 such that power flow is controlled between the ESS and grid by determining the type of conversion (DC to AC, or AC to DC), and the power of the conversion of converter 100. In some embodiments, converter 100 is able to act in AC to DC or DC to AC mode to add or subtract power respectively to the DC bus. In some embodiments, PV 200 includes a reverse blocking diode to stop reverse power being fed to PV 200.

In another embodiment, ESS 104 is an electric vehicle 104, or other DC source, sink, or storage device.

In some embodiments, electric vehicle charging station 500, or distributed energy resource 500, or other implementations are aggregated and orchestrated into a wider virtual power plant (VPP) connected through macro-grid 105. In such embodiments, implementations of multimodal systems 500 can act together in aggregate to provide primary or ancillary services to grid 105. Multimodal systems 500 can act to provide services such as importing power, exporting power, frequency response, phase or load balancing, power factor correction, time shifting, peak shaving, and the like.

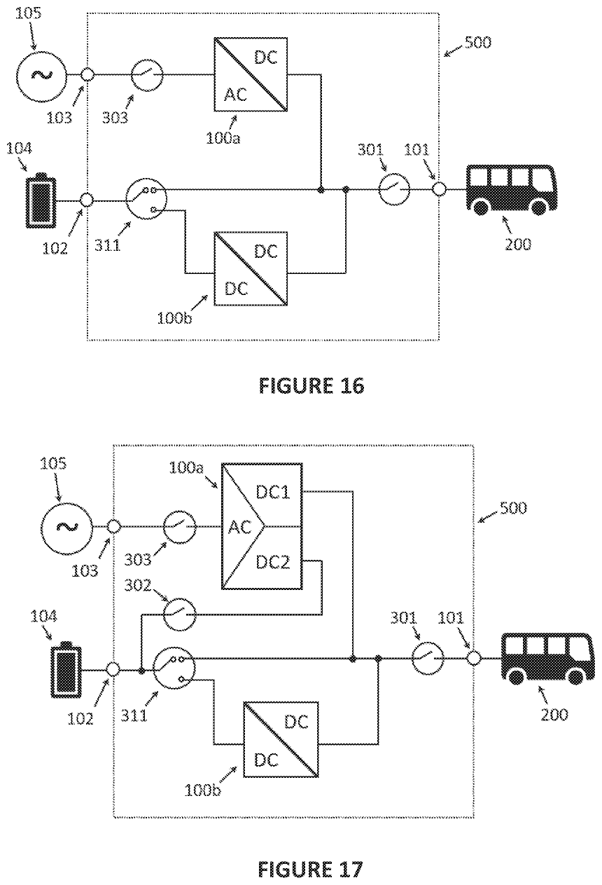

FIG. 16 is a charging station 500 comprises of dedicated AC to DC converter 100a and dedicated DC to DC converter 100b. In this embodiment, charging station 500 can optimise each converter's design to be able to perform a single function, whilst using surrounding switching mechanisms 303, 301, and 311 to direct power flows to increase the versatility and functionality of charging station 500. In this way, charging station 500 is a multimodal converter able to convert AC to DC, and DC to DC, at different power levels, whilst having a low cost and simplified design.

The charging station is used to buffer peak electrical demand from the grid whilst still providing high power output to EV 200. This is achieved by storing energy in ESS 104 via an AC to DC rectification, and then drawing upon this stored energy in ESS 104 to charge EV 200 via a DC to DC conversion when required. At the same time as charging EV 200 via a DC to DC conversion, charger 500 is able to simultaneously convert energy from the grid 105 to EV 200.

In this embodiment, in a first mode of operation, controller 300 uses converter 100a to rectify current from grid 105 at AC input 103 to charge ESS 104 by closing switch 303 and connecting the DC output of converter 100a to ESS 104 via the single-pole-double-throw (SPDT) switch 311. In this mode, controller 300 regulates a charging current or voltage to recharge ESS 104 from AC source 105. In another embodiment, converter 100a is bidirectional, and in a similar mode of operation, controller 300 exports power from ESS 104 to grid 105 via converter 100a.

In a second mode of operation, controller 300 disconnects the output of converter 100a from ESS 104 using switch 311, and closes switches 301 and 303 to connect converter 100a to EV 200 and grid 105 respectively. Controller 300 then regulates a charging current or voltage from grid 105 to EV 200 using converter 100a in AC to DC rectification mode. In a similar mode of operation, controller 300 regulates a charging current or voltage to provide power to grid 105 from EV 200 in DC to AC inversion mode (e.g. V2G operation).

In a third mode of operation, controller 300 connects ESS 104 to the input of converter 100b, closes switch 301, and regulates a charging current or charging voltage to charge EV 200 from ESS 104 using converter 100b. In a similar mode of operation, controller 300 regulates a charging voltage or current to charge ESS 104 from EV 200.

In some modes of operation, the second and third and similar modes of operation are not mutually exclusive. For example, controller 300 can act to recharge EV 200 from grid 105 via converter 100a in the second mode, and supplement the power output via converter 100b drawing energy from ESS 104 in the third mode.

In a fourth mode of operation where EV 200 has an onboard DC charger (that is, an onboard DCDC regulator), controller 300 may operate in the first mode to connect ESS 104 to the output of converter 100a, and by closing the switch 301, such that EV 200 is also connected to ESS 104. In this mode, EV 200 may regulate a charging current or voltage onboard by drawing upon energy in ESS 104, and/or current supplied by converter 100a. Controller 300 may operate converter 100a to precisely control the amount of current being supplied or drawn by ESS 104 during this period, by either importing or exporting power to AC grid 105.

In some embodiments, controller 300 dynamically controls the conversion power of converter 100a and 100b to charge EV 200. In some embodiments the power limit of grid 105 is capped, and therefore when EV 200 requests a charging power lower than the capped limit, EV 200 is supplied entirely from grid 105. Similarly, when EV 200 requests a power greater than the power cap of grid 105, controller 300 uses converter 100b and optionally converter 100a in parallel to charge EV 200.

In some embodiments, charging station 500 has further AC or DC inputs (for example solar DC input 102c), and/or other converters (for example converter 100c), to interface with other power sources, such as solar panels, wind, a backup generator, or the like.

In the embodiment illustrated, switch 311 is a SPDT switch which connects the ESS 104 at DC input 102 to either the input of converter 100b, or the output of converter 100a. Switch 311 is designed such that the DC output of converter 100a can never connect to the DC input of converter 100b. This simplifies the design, and eliminates the possibility of a short circuit across converter 100b. Cost is therefore reduced as no further protection circuitry (such as reverse protection diodes, switches, etc) is required for converter 100b, however fuses may still be employed. In addition, converter 100b is also able to act bidirectionally, as the input and output are discrete and are not able to be connected together.

In other embodiments, switch 311 is other than a SPDT switch, or constitutes multiple switches to achieve the desired result/function. In some embodiments using multiple switches, hardware or software interlocking is used to ensure the battery is never connected to both the converter 100b and output of converter 100a simultaneously. In some embodiments, a pre-charge circuit is used in conjunction with switch 311 to charge either or both of the other DC rails connected to switch 311 to the voltage of ESS 104. In other embodiments, converter 100a and/or converter 100b are used to pre-charge the rails.

In the present embodiment, converter 100a is an isolated AC to DC topology and provides galvanic isolation of both ESS 104 and/or EV 200 from grid 105. In other embodiments converter 100a is a non-isolated topology, and a further galvanic isolation transformer 106 may be applied between converter 100a and switch 303, or between switch 303 and AC input 103.

In the present embodiment grid 105 is three-phase, and therefore input 103 has three or more terminals (optionally including neutral, and/or earth), and switch 303 has three or more poles. In other embodiments, grid 105 is single phase, and AC input 103 has two or more terminals (optionally including earth), and switch 303 may break one or both poles.

In some embodiments, controller 300 or charging station 500 has communication with EV 200 to determine the required charging current or voltage.

In some embodiments, controller 300 receives further information such as dynamic conditions of grid 105 including demand response request and wholesale spot pricing, weather conditions, fleet management input and other data to determine the mode of operation.

FIG. 17 is another embodiment including a multi-modal converter and a DC to DC converter which may be applied to charging station 500. In the illustrated embodiment converter 100a is multi-modal and can operate in AC to DC mode, or DC to DC modes. The main DC output of converter 100a (DC1) is connected to the DC output of converter 100b and selectively to the output 101 and EV 200 (when coupled) via switch 301. The auxiliary DC output of converter 100a (DC2) is selectively connected to ESS 104 via switch 302.

In this embodiment controller 300 is able to charge ESS 104 from grid 105 via closing switch 303, opening switch 301, and using switch 311 to connect ESS 104 to the main output (DC1) of converter 100a, and operating converter 100a in AC to DC1 main rectification mode.

In another mode of operation, controller is able to charge EV 200 coupled at DC output 101 from grid 105 via closing switches 301 and 303, and opening switch 302, and operating converter 100a in AC to DC1 main rectification mode. In this mode, controller 300 may also instruct converter 100b to supplement the charging current or voltage of EV 200 by performing a DC to DC conversion from ESS 104 to EV 200, with switch 311 configured to selectively couple ESS 104 to the input of converter 100b. In this way, energy delivered to EV 200 is derived from both grid 105 and ESS 104, and the power delivered to EV 200 is able to exceed the individual power capacity of either source or converter individually.

In another embodiment controller 300 is alternatively able to charge ESS 104 from grid 105 via switches 302 and 303, and converter 100a operating in AC to DC2 auxiliary rectification mode.

In the present embodiment, in modes where converter 100a is configured to perform an AC to DC rectification, switch 302 is open, else switch 311 is configured to connect ESS 104 to the main output of converter 100a.

In another mode of operation, controller 300 is able to charge EV 200 from ESS 104 via closing switches 301 and 302, opening switch 303, connecting switch 311 to the input of converter 100b, and operating converter 100a in DC2 to DC1 DCDC conversion mode. In this mode, controller 300 is also able to instruct converter 100b to perform a DC to DC conversion to simultaneously charge EV 200 in parallel. In this case, both converters are configured to perform DC to DC conversions to charge EV 200 from ESS 104, therefore enabling a higher power transfer to occur.

In other modes, controller 300 is able to charge EV 200 from ESS 104 using converter 100b only.

In all the modes, charging current is able to selectively flow in either direction if the converter supports bidirectional operation.

In some embodiments, one or more further switches are employed on the main output (DC1) of converter 100a between the output and either or both of switches 301 and 311.

Converter 100a and/or 100b and/or 100c can be constructed of any of the multi-modal converter designs in this specification, or any other multi-modal converter design. For converters requiring only ACDC or DCDC operational modes, converter structures may be simplified, and/or traditional topologies used. Converters 100a and/or 100b and/or 100c can be a high, medium, or low frequency converter of unidirectional or bidirectional topology.

In this embodiment, each converter, for example 100a and 100b, employ input and/or output filtering on each of their respective input and outputs. In other embodiments, special filters are employed on each of the inputs and outputs (being 101, 102, 103) of charging station 500, in addition to, or instead of, any input and output filtering on the converters.

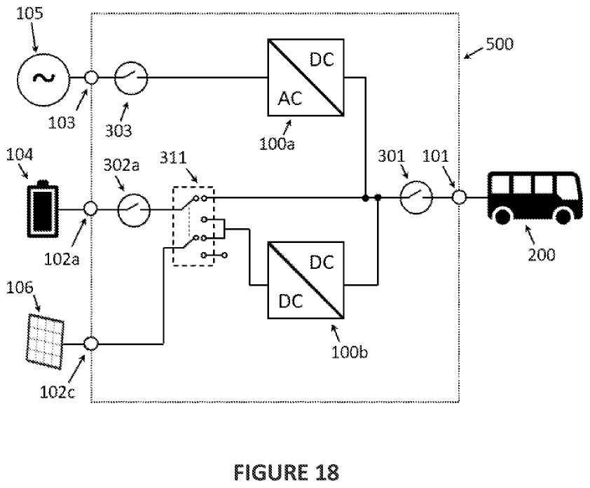

Reference is now made to FIG. 18 for another embodiment of a charging station 500 with three DC input/outputs 101, 102, and 102c, and one AC input/output 103. In this embodiment, converter 100a is illustrated as a dedicated AC to DC rectifier, and this embodiment has at least all of the operation modes of those described for FIG. 16. In another embodiment, converter 100a is a multi-modal converter, and the embodiment has at least all of the operational modes described in FIG. 17. In one embodiment where converter 100a is a multi-modal converter, auxiliary DC output (DC2) is connected between switch 302a and switch 311. In another embodiment where converter 100a is a multi-modal converter, a further switch 302 is employed between DC2 and input 102a as described in FIG. 17.

In the present embodiment, an additional input 102c is connected to a solar PV panel array 106. The DC input 102c is connected to an input of a double pole double throw (DPDT) switch 311. In this embodiment, the common of the first pole of switch 311 connects to DC input 102, with the normally closed throw connected to the output of converter 100a, and the normally open throw connected to the input of converter 100b. The common of the second pole of switch 311 is connected to DC input 102c, with the normally closed throw connecting to the input of converter 100b (that is, bridged with the normally open throw of the first pole), and the normally open pole being open circuit.

In one mode of operation, converter 100a can charge ESS 104 from grid 105 via closed switch 302a and 303, and the normally closed switch of the first pole of 311, whilst converter 100b acts as a maximum power point tracking (MPPT) device for simultaneously charging ESS 104 from solar array 106 via the normally closed switch of the second pole of 311. Controller 300 may instruct converter 100a and/or 100b to act independently, singularly, in tandem, synchronised or unsynchronised for charging ESS 104 in this mode.

In another mode of operation, controller 300 may instruct converter 100a to charge EV 200 from grid 105 via closed switch 301 and 303. Simultaneously, or independently, controller 300 may instruct converter 100b to charge EV 200 from energy derived from ESS 104 or solar PV array 106 via selectively controlling the switching state of DPDT switching mechanism 311 and switch 302a. In one state, switching mechanism 311 is configured in its normally closed state, switch 302a is open, and controller 300 instructs converter 100b to perform a MPPT charger from PV 106 to EV 200. In another state where solar PV power generation is deemed insufficient or unwanted, switching mechanism 311 is actuated to close its normally open contacts, switch 302a is closed, and controller 300 instructs converter 100b to charge EV 200 from ESS 104.

In another embodiment, switching mechanism 311 is other than a DPDT switch, and made up of other switching types. In one embodiment, switching mechanism 311 is made up of two independently controlled SPDT switches. In some embodiments, switch 302a (and/or switch 302 where present) are combined in switching mechanism 311, or are eliminated.

In another embodiment, the normally open throw of the second pole of switch 311 is connected in parallel to the main output of converter 100a, or to the input of another converter (not shown).

In this embodiment, ESS 104 is able to be charged from either grid 105, or PV array 106. Furthermore, EV 200 is able to be charged from grid 105, and simultaneously from ESS 104 and/or PV array 106 to increase the power output of charging station 500, whilst having minimal power conversion stages, thereby reducing the cost, weight, and size of charging station 500.

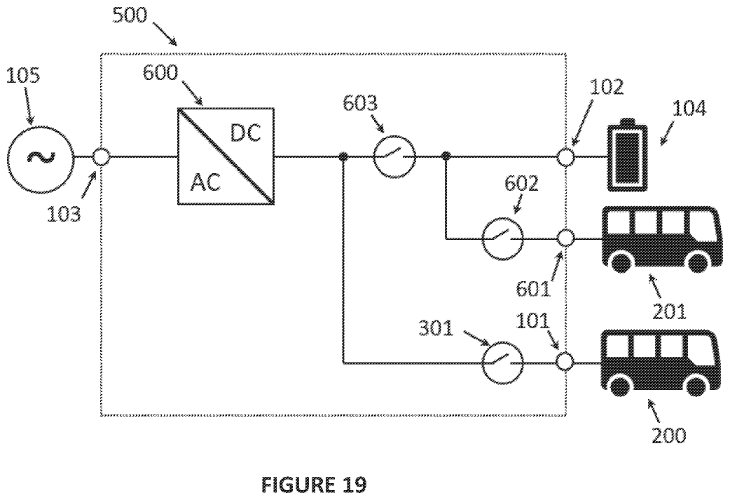

Reference is now made to FIG. 19 of another embodiment of a charging station 500. In this embodiment station 500 is able to enable a charge of an electric vehicle 200 at DC input 101, and/or EV 201 at DC input 601. In this example, DC input 601 is reserved for electric vehicles which include an onboard DC to DC charger, as is becoming increasingly common for new generation higher voltage passenger electric vehicles (e.g. 800V) and commercial electric vehicles.

When electric vehicle 201 connects to station 500 at DC input 601 and communication between vehicle and charging station takes place to ensure compatibility. Examples of such communication include CCS or CHAdeMO protocols. If vehicle 201 is deemed to include an onboard DC charger of compatible voltage, then the charging process is allowed. On request, controller 300 closes switch 602 to expose EV 201 to the floating voltage of a DC source connected at DC input 102 (exemplified in this embodiment as ESS 104). EV 201 may then draw upon the DC voltage and regulate its own charging current or voltage onboard. Throughout the initiation process controller 300 communicated the allowable current or voltage limits for the vehicle 200 to obey, and therefore EV 200 does not draw more current than allowed, or cause the voltage to exit the boundary conditions. If controller 300 deems that EV 201 is not obeying or responding to the boundary limits, then it may disconnect EV 201 via switch 602. Controller 300 may intermittently communicate new boundary conditions throughout the charging event. For example, as ESS 104 state-of-charge changes, or with varied temperature, the current and voltage boundary conditions may also need to be dynamically adjusted.

Throughout the charging process of EV 201, controller 300 may choose to augment the current being drawn or supplied to ESS 104 by closing switch 603 and providing or drawing current from converter 600. Ammeters fitted to the DC input 102 and/or 601 and/or converter 600 enable controller 300 to blend power between ESS 104 and converter 600 to achieve a desirable outcome.

If a vehicle 200 presents at DC input 101 whilst vehicle 201 is charging at DC input 601, controller 300 may choose to allow it to charge simultaneously. If vehicle 200 also has an onboard DC charger, then after communication is established and compatibility confirmed, controller 300 may choose to close switches 301 (and 603 if not already closed) such that vehicle 200's onboard DC charger may also draw upon converter 600 and ESS 104. In this case, EV 200 and EV 201 are not galvanically isolated from one another. If EV 201 is not present, or finishes charging, then controller 300 acts to open switch 602 such that only EV 200 is actively connected to station 500.

In some embodiments EV 200 does not have an onboard DC charger and therefore controller 300 may use converter 600 to charge EV 200 directly. This necessitates that switch 603 is open such that ESS 104 is not able to connect to EV 200. In such cases, EV 200 communicates with controller 300 to determine the requested charging parameters, and if compatible, controller 300 may close switch 301 and control converter 100 to provide the requested charging current or charging voltage to EV 200. If vehicle 201 is present, it is able to charge from ESS 104 simultaneously with switch 602 closed.

In the case where EV 200 and EV 201 are not galvanically isolated from one another (for example when switches 301, 602, and 603 are closed), good design principles are assumed of the vehicles and charging station to ensure total earth leakage current does not exceed the specified limit. For example, the charging station may have one or more residual current devices to monitor both AC and DC earth leakage currents. Furthermore EV 200 and EV 201 may employ onboard isolation monitoring and/or onboard earth leakage monitoring devices to ensure safe operation.

ACDC converter 100 may consist of any of the converters disclosed herein, or be of another type of ACDC rectifier, of unidirectional or bidirectional type, and may provide galvanic isolation.

In other embodiments, switch 302 is employed to selectively disconnect ESS 104 from the common point of switch 602 and 603. In embodiments with switch 302 employed, controller 300 is able to charge a vehicle 201 which does not have an onboard DC charger by opening switches 301 and 302 and closing switches 602 and 603, and using converter 600 to provide a regulated charging current or voltage to EV 201.

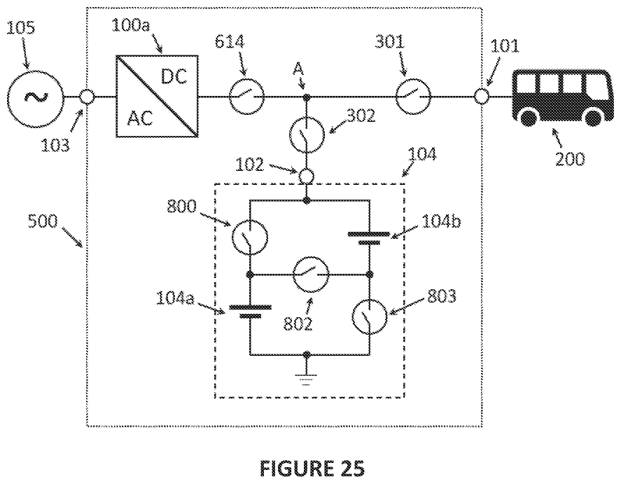

In one example of the embodiment, ESS 104 consists of two or more battery pack configuration subsets, and a switching mechanism which can either place the battery subsets in parallel or in series, or in another configuration of series and parallel. In this way, the voltage range of converter 600 may be able to be reduced, or optimised around a specific voltage range. For example, in one embodiment converter 600 is optimised or only capable of outputting between 200 VDC and 500 VDC, where each of the battery packs subsets are rated to 400V and placed in parallel to be able to be charged from converter 600. If EV 201 connects to interface 601 and communicates that it is able to charge from an unregulated 800V DC source, then controller 300 instructs the switching mechanism to place the battery subsets in series to create an 800V source, such that EV201 may use an onboard DC charger to charge from ESS 104 as an 800V unregulated DC source. Further illustration and description of this concept is provided in reference to FIG. 25.

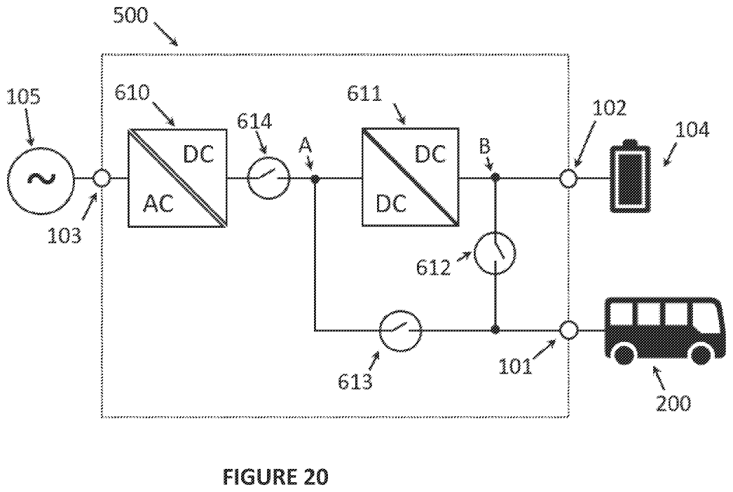

Reference is now made to FIG. 20 of another embodiment of a charging station 500 with multimodal converter 100 further consisting of converters 610 and 611, where station 500 can operate to charge EV 200 from either or both grid 105 and/or ESS 104. In this embodiment, converter 610 may be analogous to converter 100a, and converter 611 may be analogous to converter 100b of prior converters.

In one mode of operation converter 100 acts to recharge ESS 104 from grid 105 by operating ACDC rectifier 610 and DCDC converter 611 in series with optional switch 614 closed, and switches 612 and 613 open. Alternatively, in cases where voltage compatibility allows, switches 612 and 613 may be closed such that ACDC converter 610 may charge ESS 104 directly without series conversion losses of 611. In some embodiments switch 301 (not illustrated, but exemplified in previous figures) is employed to disconnect DC input 101 (and thus EV 200) from the intersecting point of switch 612 and 613 such that converter 610 may charge ESS 104 even when EV200 is connected to the interface 101, or that an inrush current does not flow to EV200 upon sudden connection.

In one example application, converter 611, ESS 104, and switches 612 and 613 are added to upgrade the power and/or voltage capability of an existing EV charging station. In this example the pre-existing charging station consists of ACDC converter 610, which is capable of outputting a regulated current or voltage up to a maximum ˜500 VDC or in line with older CCS or CHAdeMO charging standards. The goal of the upgrade in this example is to enable wider voltage output up to 920 VDC in line with CCS2 HPC standards, and/or to enable higher power charging. This may include optimisations for EVs with high-powered onboard DC chargers as may be fitted to newer generation higher voltage (e.g. 800V, 1200V) EVs.

In this example, when an EV 200 with traction battery of 400V is connected at DC input 101, after communication is established and accepted, controller 300 may control converter 610 to close switch 613 such that the 50 kW charger 610 may charge EV 200 directly. If the EV 200 can accept more power than output of the ACDC converter 610 can provide (in this example, 50 kW), then DCDC converter 611 may supplement the output by drawing energy from further DC source attached at DC input 102 (in this example, ESS 104) and performing a bidirectional DCDC conversion. In this example, DCDC converter 611 is rated to 125 kW so therefore the 400V combined output maximum is 175 kW. If the vehicle 200 communicates it has an onboard DC charger able to accept the voltage and parameters of ESS 104, then controller 300 can act to close switch 612 so that EV 200 may charge directly from the unregulated voltage source of ESS 104, which may be supplemented by converter 610 with switches 613 and 614 (if fitted) closed.

In one embodiment, the DCDC is able to operate in two quadrants only (2Q) to either perform a DCDC boost from point A to point B, and buck bidirectionally from point B to point A. Furthermore, if in certain applications it is known that point A is of a typical value (for example, 450V max output to converter 610), and point B is of another typical value (e.g. 800V nominal of ESS 104), then converter 611 may only need to be compatible or efficiency in a narrow band of relative voltage of A and B to reduce cost or complexity, or increase efficiency in the typical operating range of the converter. For example, converter 611 may be an isolated resonant tank DCDC converter such as an LLC optimised around a 2:1 voltage translation ratio.

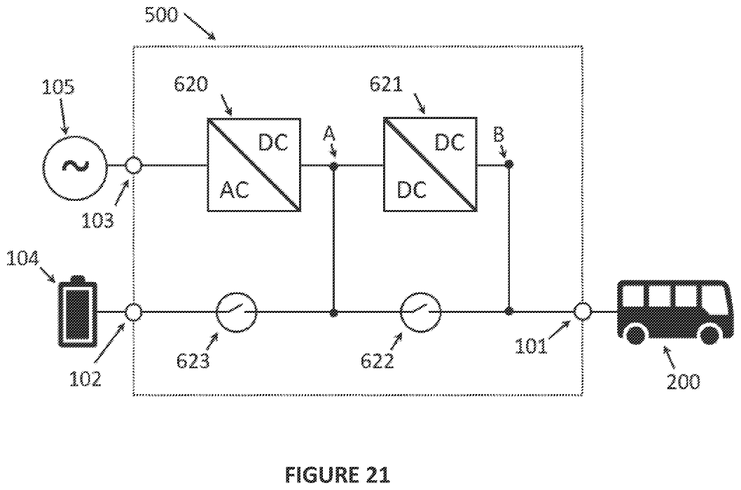

Reference is now made to FIG. 21 of another embodiment of a charging station 500 with multimodal converter 100 consisting of converters 620 and 621. In this embodiment with an EV 200 connected at DC input 101, after communication and compatibility is established, controller 300 may initiate or allow a charge to occur. If EV 200 communicates that it has an onboard DC charger capability, then upon request, controller 300 may instruct switches 622 and 623 to close such that EV 200 may draw current from the DC source at DC input 102 (in this embodiment exemplified as ESS 104) to regulate a charging current or voltage onboard within the specified bounds of station 500 communicated by controller 300 or otherwise. Controller 300 may also choose to augment current provided by ESS 104 by controller converter 620 to add current (or subtract current if bidirectional) to the DC bus. In this way, current demand can be seamlessly blended between ESS 104 and converter 620 whilst EV 200 charges itself from the DC bus presented by station 500.

In the case where it is communicated that EV 200 does not have onboard DC charger capabilities, or is otherwise incompatible with the voltage or other characteristics of ESS 104, then controller 300 may, upon request, charge EV 200 from converters 621 and/or 620. For example, if voltage compatibility allows, controller 300 may choose to keep switch 622 open and charge EV from DC to DC converter 621 drawing power from either or both of ACDC converter 620 and/or ESS 104 with switch 623 closed and switch 622 open. In this way, controller 300 is able to charge EV 200 with power blended from both grid 105 and stored energy in ESS 104, and therefore the power output at DC input 101 may exceed the instantaneous power capabilities of converter 620 and/or grid 105 at AC input 103. Alternatively, if voltage compatibility allows, controller may choose to charge EV 200 by opening switch 623 and closing switch 622 and charging EV 200 via converter 620. In this case, maximum power output is determined by the maximum power capability of converter 620 and/or AC grid 105.

Controller 300 may select the mode based on voltage compatibility of converter 620, 621 and EV 200. For example, converter 620 may only be able to output up to 500 VDC, and therefore ESS 104 is rated to a maximum of 500 VDC so that it can be recharged by converter 620 from grid 105. If when a vehicle 200 has a traction voltage of sub-500 VDC, then it too may be recharged by converter 620. In one example application, converter 621 is a DCDC boost converter only when drawing energy from ESS 104 and/or converter 620 to provide to EV 200 (that is, when translating power from point A to B). Therefore, controller 300 may choose to only use converter 621 when the traction battery of EV 200 is of higher voltage than the voltage of ESS, for example, for an EV 200 with 800 VDC nominal traction voltage. If in this example application EV 200 has a traction voltage of 800 VDC, it may still charge from the sub-500 VDC ESS by employing an onboard DC charger. In the example where converter 620 is only able to output sub-500 VDC makes the embodiment applicable to upgrading prior-art generation charging stations typical of this voltage range (for example, a charging station of maximum 450 VDC output as per early specifications of “CCS” and/or “CHAdeMO” standards).

In another embodiment of an example application, converter 620 is able to output up to 920 VDC at point A, and therefore ESS 104 is also able to be rated up to a maximum of 920 VDC. In this case, an 800 VDC EV at DC input 101 may be able to be directly charged from converter 620. In a further example embodiment, converter 621 is a buck regulator from point A to point B, and is therefore may be used to charge an EV 200 with a traction battery voltage lower than ESS 104 and/or the minimum output of converter 620 (which may be a boost rectifier). In a further example, the output of converter 621 is only rated for sub 500 VDC or lower, and therefore a high voltage output switch or diode is included at point B (or internal to converter 621) to ensure voltage stress is not imposed on converter 621 when charging vehicles at voltages above 500 VDC.

Having converter 621 able to be optimised as either a buck or boost converter may reduce cost or complexity of the converter design. Furthermore, the system may be optimised around a set voltage translation ratio, for example 2:1 to translate between 400 VDC nominal and 800 VDC nominal voltages. In other embodiments converter 621 is a buck-boost or boost-buck converter, such as the multimodal DCDC boost-buck converter described in reference to FIG. 4B.

Therefore, in embodiments having multiple converters orchestrated by controller 300 as a multimodal converter, one or more of the converters may be optimised around defined characteristics, such as voltage ratios, conversion capabilities, power requirements, and the like. Such optimisations, for example, may be to reduce cost or complexity of the converter, or improve efficiency for specific conversion parameters.

At any time, controller 300 may elect to recharge ESS 104 by closing switch 623 (if not already closed), and providing power from AC grid 105 via converter 620. This may happen simultaneously to EV 200 being charged either by its onboard DC charger or via converter 621, if the maximum power capabilities of converter 620 (and grid 105) exceed that of the power being delivered to EV 200.

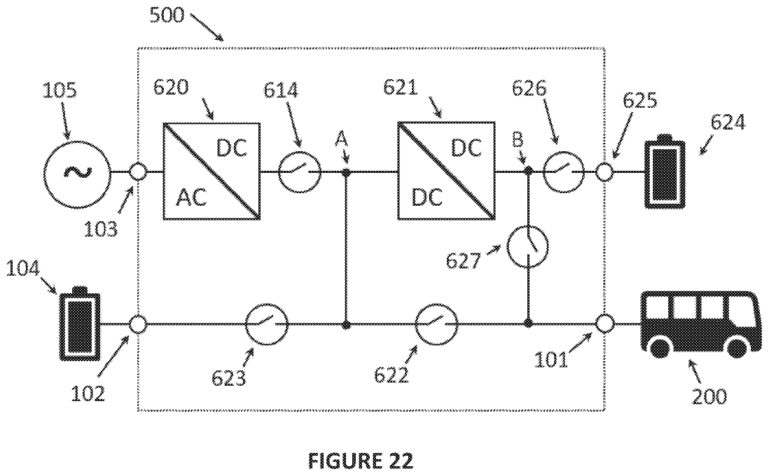

Reference is now made to FIG. 22 of another embodiment of a charging station 500 with multimodal converter 100 consisting of converters 620 and 621. In this embodiment, charging station 500 is able to be equipped with two independent DC sources exemplified as battery systems 104 and 624 at DC inputs 102 and 625 respectively, as well as EV 200 at DC input 101. Previous modes of operation may apply as per FIG. 21 with switch 614 closed.

Further to the previous operational modes described in reference to FIG. 21, Controller 300 may regulate a charge of EV 200 from ESS 624 by closing switches 626 and 622 and opening switches 627 and 623, and operating converter 621 in the bidirectional mode (from B to A). Switch 614 may be open or closed during this mode. If the voltages are compatible and switch 614 is closed, converter 620 may also be used to add or subtract current being supplied to EV 200. If the voltages are not compatible, switch 614 may be used to disconnect converter 620 from point A. In the case that EV 200 voltage is too high for converter 621 this may be done to protect the output of converter 62. Similarly, if the voltage is too low for converter to regulate the charging current or voltage (for example, if converter 620 is a boost rectifier) then it may also be disconnected. If converter 620 is never expected to be incompatible with the voltage at point A, then switch 614 may be eliminated.

If EV 200 has an onboard DC charger, then it may charge from either ESS 104 or ESS 624. Controller 300 may select the source based on voltage level, state-of-charge, power capability, temperature, or the like. If EV 200 with onboard DC charger charges from ESS 624 with switches 626 and 627 closed and switch 622 open, controller 300 may also elect to augment current by operating converter 621. In this case, converter 621 may draw or supply energy to AC grid 105 via converter 620 and switch 614, and/or from ESS 104 via switch 623. In this way, EV 200 may charge from one, two, or three of the attached sources simultaneously.

In some modes of operation, converter 621 may operate such as to balance the voltages of ESS 624 and ESS 104 such that they can be connected in parallel via switch 626, 627, 622, and 623. In this way, once connected together, they may be charged or discharged together, such as by converter 620, or by EV 200 with onboard DC charger.

In cases where EV 200 does not have an onboard DC charger, it may charge from ESS 104 and/or converter 620 via converter 621 with switches 627, 614 and/or 623 closed and switches 622 and 626 open. Alternatively, it may charge from grid 105 via converter 620 with switches 614 and 622 closed and 623 and 627 open. Alternatively, EV 200 may be charged from ESS 624 via converter 621 operating in bidirectional mode with switch 626 and 622 closed, and switches 627 and 623 open. Converter 620 may additionally add charging current or voltage with switch 614 closed.

Controller 300 may recharge ESS 624 by closing switch 626 and regulating a charging current or voltage from converter 621 drawing upon ESS 104 and/or converter 620. Whilst converter 621 is recharging ESS 624, EV 200 may be simultaneously drawing energy from converter 621, or from ESS 104 and/or converter 620. Likewise, controller 300 may recharge ESS 104 from ESS 624 via converter 621, and/or from grid 105 via converter 620.

Having multiple DC inputs as illustrated may provide multiple uses. For example, if fitted with two DC sources (exemplified as ESS 104 and ESS 624), these can be charged and discharged independently. This allows for integration of DC storage or generation of different voltages, types, capacities. In one example application, two 2^{nd} life battery packs are used at DC input 102 and 625 respectively. Each battery pack may have the same number of cells and chemistry; however, each has been subject to different lives and therefore may have a different state-of-health (SOH), maximum charge and discharge rates, energy capacity, or the like. In this case, having two independent DC inputs as the battery packs can be cycled at different rates and depth of discharge, with active balancing and management individually or between the packs. In another embodiment one or both of the DC sources are exchanged with PV solar array(s).

In some embodiments, ACDC converter 620 is not galvanically isolated whereas DC to DC converter 621 is, and therefore regulated charging current may be routed through converter 621 when charging EV 200 from grid 105. Where EV is charging from ESS 104, or bidirectionally through converter 621 from ESS 624, or other modes where EV 200 is directly connected to point A, then ACDC converter 620 may selectively be disconnected via switch 614 to enable galvanic isolation of EV 200 from grid 105.

In another embodiment, DC input 625 interfaces to a further EV 200b, and charging station 500 may charge both EV 200 and EV 200b simultaneously. In such an embodiment, with switch 627 open, DCDC converter 621 can charge EV 200b via switch 626, and ACDC converter 620 (and/or ESS 104 via switch 623) can charge EV 200. In the case where EV 200 does not have an onboard DC charger, then switch 623 should be open, and ACDC converter 620 can output a regulated output which supplies both DCDC converter 621, and EV 200. If EV 200 is requesting constant current mode, then the current output supplied to EV 200 is equal to the output of ACDC converter 620 minus the current drawn by DCDC converter 621.

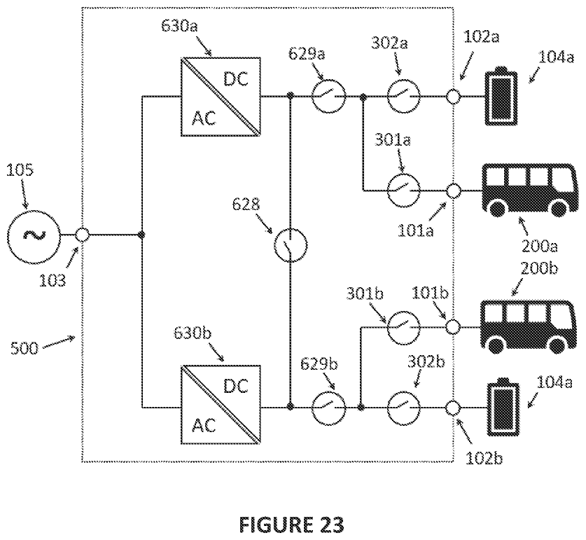

Reference is now made to FIG. 23 representing a further schematic for a charging station 500 with two DC inputs 102a and 102b, and two EV inputs 101a and 101b. In this embodiment, station 500 has two converters 630a and 630b. In this embodiment, converters are galvanically isolated ACDC rectifiers using high, mid or low frequency transformer technology. In another embodiment a common transformer 106 (not shown) with dual isolated secondary windings 106a and 106b feeds galvanically isolated AC power to converter 630a and 630b respectively. In this embodiment, charging of EV 200a (and operation of 301a, 302a, 629a, 104a, and 630a) operates similarly but mostly independently of charging of EV 200b (and operation of 301b, 302b, 629b, 104b, and 630b), and therefore repeat operational modes relating to either may be omitted from the specification. In this embodiment, with switches 301 and 629 closed and 302 open, EV 200 (either 200a or 200b) without an onboard DC charger may charge from converter 630 (respectively 630a, 630b) from grid 105. If EV 200 has an onboard DC charger, then switch 302 can also be closed such that EV 200 may draw upon energy of both ESS 104 and converter 630. As 630a and 630b are galvanically isolated, EV 200a and EV 200b may charge simultaneously and be galvanically isolated from one another.

Controller 300 may choose to only charge either EV 200a or 200b (for example, if only one is present), using both 630a and 630b and/or ESS 104a and 104b by closing switch 628, and opening the corresponding switch to the EV not being charged (either 301a or 301b). In this way, the EV being charged may be able to charge up to double the speed. Both EVs may charge simultaneously with switch 628 closed whilst being galvanically isolated if at least one of the of the EVs has an onboard DC charger and is able to charge directly from ESS 104 with corresponding switch 629 open. In this case, the other EV is able to charge using both converters 630a and 630b, and the other ESS 104 if it too has an onboard DC charger. Similarly, one of the EVs (for example, EV 200a) with onboard DC charger can charge from both ESS 104a and 104b and converter 630a and converter 630b with switch 628, 629a, 629b, 301a, and 302b closed, and its EV disconnect switch closed (for example, 301a), and the other EV switch open (for example, 301b).

In another mode of operation, with just one EV 200 connected to be charged, controller 300 may use both converters and their common AC power bus connected to AC input 103, and the ESS 104 corresponding to the electric vehicle interface 101 without an EV connected, to deliver at least one of a regulated charging current or a regulated charging voltage to the EV 200 which is connected. For example, if EV 200b is to be charged, controller 300 may open switches 301a, 628, and 302b, and close switches 302a, 629a, 629b, and 301b, such that converter 630a can operate in the bidirectional mode to draw energy from ESS 104a and supply it to the common AC power bus to offset, at least in part, energy being drawn from the common AC power bus by converter 630b which is operating to deliver at least one of a regulated charging current or voltage to EV 200b.

One of the aspects of such an embodiment is that either EV 200a or 200b can be charged at a higher power, or power can be distributed to both EV 200a and 200b simultaneously at varying levels. This disclosure may be expanded to include more than two EV outputs 101, or DC inputs 102. For example, in other embodiments, further EV interface and/or DC source interfaces are implemented, such as to charge three or more electric vehicles, and/or interface with three or more battery systems.

The combination of converter 630, and switches 302 and 301 combined may create a multimodal converter structure between an AC source (being grid 105) and multiple DC sources (e.g. ESS 104 and EV 200). In this way, FIG. 23 may enable a similar embodiment functionality to FIG. 14 for example, where DC outputs of each converter may be combined to increase the power level delivered to one of the DC sources.

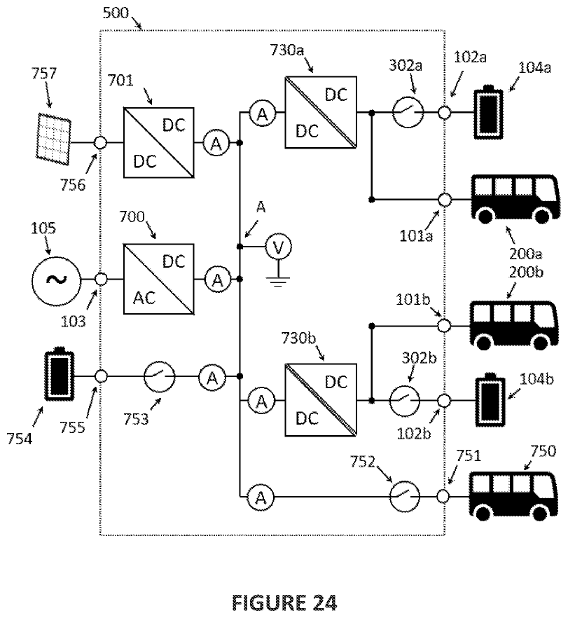

Reference is now made to FIG. 24 of a further schematic of multimodal charging station 500. Charging station 500 may include one or more AC to DC rectifiers 700 from AC grid 105 to the main DC bus at point A. Further station 500 may include two or more DC to DC converters 730 (illustrated as 730a and 730b) to selectively charge an EV 200 at DC input 101 (illustrated/shown as EV 200a and EV 200b), or DC source at DC input 102 (illustrated as ESS 104a and 104b). Station 500 may include a further DC source (exemplified as PV array 757) at a further DC input 756 and further DC to DC converter, illustrated as converter 701 connected to main DC bus A. Station 500 may also include a DC buffer on the main DC bus A as exemplified by ESS 754 at DC input 755, and selectively coupled with switch 753. Lastly, station 500 may include a further EV input 751 for interfacing with an EV 750, and selectively coupled to the main DC bus A via switch 752.

Each of the converters 700, 701, 730a, and 730b may supply and/or draw current from the main DC bus by operating in various modes. Similarly, EV 750 may supply and/or draw current from the DC bus A if fitted with onboard DC charger converter and connected via switch 752. If ESS 754 is connected to DC bus A, then the current flowing in or out of ESS 754 must equal the sum of the currents of the other DC sources or sinks (assuming no leakage current) via Kirchhoff's current law (KCL). Similarly, in the case where EV 750 is connected via switch 752 and not fitted with an onboard DC charger, then a charging current can be regulated by controlling the DC current of each of the other converters with unregulated ESS 754 disconnected. In cases where EV 750 does not have an onboard DC charger fitted, controller may act to ensure switches 752 and 753 are never closed at the same time to avoid an unregulated current flow to occur between the two DC sources.

If EV 750 has an onboard DC charger fitted, it may therefore draw current from all the attached energy sources (including ESS 754), and therefore charge at very high power, limited primarily by the power capability of its onboard DC charger (ignoring cabling, fusing, ancillaries, power source limitations, etc). If EV 750 is not fitted with an onboard charger, then its power is primarily limited by the combined power capacity of one or more optionally fitted converters 700, 701, and 730 or their associated power sources.

In embodiments fitted with optional EV input 751, it may be that ACDC converter 700 (if fitted) is of galvanically isolated design (or include isolation transformer 106), or is disconnected (e.g. through switch 614 not shown) prior to connecting EV 750 via switch 752. In this way, EV 750 may be isolated from the grid which may be used for some DC charging standards.

An attached EV 200 without onboard DC charger may charge from DC to DC converter 730 with switch 302 open. DC converter may draw upon energy from other converters (including other similar converters 730), and/or ESS 754 to provide additional current to EV 200. An attached EV 200 with onboard DC charger may similarly draw current from DC to DC converter 730, as well as from ESS 104 with switch 302 closed. If EV 200 with onboard DC charger draws less current than can be provided by ESS 104, then converter 730 may operate in bidirectional mode to draw further current from ESS 104 to supply to DC bus A for other purposes. For example, DCDC 730 operating in bidirectional mode may assist in charging of EV 750, another EV 200 at an alternative position (e.g. 101b), providing a regulated charging current or voltage to ESS 754, or exporting energy to grid 105.

Controller 300 may use converter 700, or any other converter, as a source or sink to balance currents on the DC bus A. For example, if excess solar is being generated and ESSs 754 and 104 are at full state-of-charge or not able to accept more charge, and any attached EV are charging at full potential, the controller 300 may export excess power to grid 105 via bidirectional converter 700.

In this embodiment, converter(s) 730 provides galvanic isolation, so therefore other converter types, or the main DC bus at point A, may not need to be isolated which may help reduce the cost, weight and size of the charging station.

In another embodiment, a transformer 106 is included to provide galvanic isolation between AC input 103 and ACDC converter 700. Alternatively, converter 700 may be of isolated topology. In such implementations, the DC bus A is galvanically isolated from the AC electrical grid 105.

Another embodiment may include EV disconnect switches 301a and 301b. In another embodiment station 500 also includes a switch 628 to bridge the DC outputs of converters 730a and 730b to selectively increase the power output of either.

In another embodiment, each EV input (e.g. 101a, 101b, 751) includes a further DC to DC converter 770 to regulate the power output. For example, DC to DC converter 770a could assist to charge EV 200a without onboard DC charger from ESS 104a with switch 302a closed. Similarly, to the above operation converter 730a may also augment the current being drawn on ESS 104a by DC to DC converter 770a. This additional DC to DC converter is analogous to the onboard DC charger equipped in some EVs, and operates and is interchangeable in a similar manner.

In most embodiments, a switch 301 (not illustrated for simplicity) is implemented between one or more of the EV output(s) 200 and DCDC converter(s) 730. For example, a switch 301a implemented between EV 200a at input 101a, and converter 730a and switch 302a. Such a switch 301 is typical for selectively connecting the vehicle to the charging station upon successful communication, compatibility, availability, or other. Further, this switch may ensure no DC voltage is presented to the EV interface 101 when no EV 200 is connected, and is often required by standards and best practice.

In some embodiments, DC bus A may include a common filter, EMI suppression, or other mechanism to improve the stability and reduce noise of the DC bus. In some embodiments, filters on each of the DC bus interfaces may be employed.

Reference is now made to FIG. 25 of another charging station 500 for an EV 200, for charging from either an AC source at AC interface 103 illustrated as grid 105 and/or a DC source at DC interface 102 illustrated as ESS 104. In this embodiment, ESS 104 comprises two sub battery packs of ESS 104a and ESS 104b and a switching mechanism comprising of switches 800, 802 and 803 able to selectively connect the two sub battery elements in series or parallel. In this way, controller 300 can manipulate the voltage and/or current characteristics of ESS 104 to optimise one or more characteristics of the intended operation. In some embodiments, charging station 500 includes a communication module for communicating with EV 200 to determine voltage and conversion compatibilities. In some embodiments, controller 300 employ a battery management system of the ESS 104 such that controller 300 is able to know the state-of-charge, voltage, temperature, state-of-health and/or other characteristics of the battery system to determine the optimal mode of operation. In a first mode of operation, controller 300 closes switch 302 (and 614 if fitted) and opens switch 301 such that converter 100a may provide at least one of a regulated charging current or a regulated charging voltage to ESS 104. In a second mode of operation, controller 300 opens switch 302 and closes switch 301 (and 614 if fitted) such that converter 100a may provide at least one of a regulated charging current or a regulated charging voltage to EV 200. In a third mode of operation, controller 300 closes both switches 301 and 302 such that EV 200 with an onboard DC charger may draw current from ESS 104 (and/or converter 100a with switch 614 closed) to regulate it's charging current or voltage onboard. In this further mode of operation, if the voltages are compatible, controller 300 may close switch 614 and regulate the proportion of current to be derived by ESS 104 by supplying current from converter 100a. If EV 200 draws a current lower than the maximum permissible by ESS 104, controller 300 may also operate converter 100a to draw further current form ESS 104 simultaneously to export to grid 105. If EV 200 supplies current to charging station 500, this may be stored in ESS 104, or exported to grid 105 via converter 100a. If the voltages are incompatible between point A and the output of converter 100a, then controller 300 may open switch 614 to protect the output stage components of converter 100a. If the voltage of point A and the output of converter 100a are always expected to be compatible in certain applications, or if converter 100a already has a protected output stage, then switch 614 can be eliminated from the circuit. In one example application, converter 100a is an AC to DC rectifier with an output voltage optimised around 450 VDC, EV 200 has an onboard DC charger capable of accepting up to 920 VDC, and ESS 104a and ESS 104b each have a voltage of 400 VDC. In this example application when controller 300 operates in the first mode, controller 300 places battery pack subsets 104a and 104b in parallel such that the voltage presented by ESS 104 is 400 VDC and within the bounds of converter 100a. Controller 300 achieves this by closing switches 800 and 803, and opening switch 802. In the example application when controller 300 operates in the third mode, controller 300 may place the battery sub elements 104a and 104b in series to achieve a higher voltage of ESS 104, this is achieved by closing switch 802 and opening switches 800 and 803. In this way, EV 200 may draw upon the 800V load of ESS 104 (and converter 100a with switch 614 closed, if voltages are compatible) using its onboard DC charger. A higher voltage may be used to transfer power between the charging station 500 and electric vehicle 200 such that current and therefore losses are reduced, which may allow for smaller cabling to be used. If the output of converter 100a is deemed compatible with either the direct traction battery voltage of EV 200 or the onboard DC charger of EV 200, then controller 300 may operate in the second mode.

In an alternative application example, controller 300 places the battery sub packs 104a and 104b in series when operating in the first mode, and places the battery sub packs modules 104a and 104b in parallel when operating in the third mode. In some applications, controller may operate with battery sub packs 104a and 104b in series or parallel depending on a range of factors from communication with either ESS 104 or EV 200, current and voltage feedback sensors, temperature, state-of-charge of ESS 104, state-of-charge of EV 200, communication with a cloud server, or the like.

In another embodiment, ESS 104 comprises more than two sub packs, and more switches such that sub packs can be placed in further varying configurations of series and parallel.

Throughout this specification commonly used elements which are not essential, but may be required to implement the disclosure may be omitted. It will be readily appreciated that a person skilled in the art would be able to apply such commonly used elements, components or techniques without undue experimentation to realise and perform the disclosure. For example, fusing, insulation monitoring, filtering, voltage and current or other sensor feedback, isolation switching, communication modules, controllers, and the like which may not be illustrated in some or all of the embodiments or variations as described. In addition, those skilled in the art would readily appreciate that such components and/or controlling may be required in applications to achieve a desirable outcome, to meet standard regulations, guidelines and/or best practices.

The ESS switches 800, 802, and 803 as illustrated in reference to FIG. 25, or the like, may also be applied to any aforementioned embodiments with ESS 104 to achieve similar benefits and modes of operation. Switches 800, 802, and 803 may be controlled by an internal battery-management-system (BMS) of ESS 104, wherein the mode selection is determined by the BMS system depending on the intended operational mode, or in conjunction with communication with controller 300.

Reference to this specification is made to the communication between the electric vehicle (often exemplified as EV 200) and controller 300 of station 500. Such communication can be of open or close/proprietary standard, or consist of another simple communication means such as a proximity sensor, resistor, voltage, key, manual button, HVIL, or the like. In embodiments where communication is not described, it is assumed that communication may be provided where appropriate by controller 300 to ensure compatibility and safe operation.

Reference throughout this specification is referenced to charging an electric vehicle (for example, EV 200) from charging station 500, however, in many cases where bidirectional converters are applied (both in the charging station's converters, or vehicles onboard Dc charger converter), the vehicle may supply energy back to one or more of the energy sources connected to station 500. For example, EV 200 may serve to recharge ESS 104, or export power to grid 105 in V2G mode by operating one or more converters in their bidirectional mode.

In embodiments, DC sources exemplified as battery energy storage systems (ESS) may be replaced with other DC sources such as PV solar panel arrays, and vice versa.

It will be appreciated to anyone skilled in the art that the MOSFETs shown can instead be implemented by other switch types including IGBT, SiC, GaN, relays, diode, or any other electrical switching component.

It will be appreciated by those skilled in the art that the switching mechanisms shown can be implemented using contactors, relays, mechanical switches, solid state switches, diodes, or the like.

It will be appreciated by those skilled in the art that one or more of the converter structures detailed in FIG. 2 to FIG. 10 may be applied to the charging station designs as detailed in FIG. 11 to FIG. 24.

The multimodal converters described herein may have one or more of the following aspects:

Ability to use the same electrical components for AC to DC conversions, DC to AC conversions, and DC to DC conversions.

Saves considerable cost, space, and weight over comparable solutions.

Provides the ability to selectively choose buck or boost configurations.

Increases the power able to be delivered by the converter by allowing optimized input voltages of multiple sources.

Increases versatility of the converter by enabling conversions between multiple sources or sinks of AC or DC.

Enables peak shaving and load shifting operation.

Ability to improve load factor and reduce peak demand of AC grid whilst maintaining high-power output.

Ability to use integrated storage to increase power output beyond AC grid limitation.

Bidirectional operation for vehicle to grid, storage to grid, or other source to grid operation.

Can provide ancillary services such as frequency correction, power factor correction, voltage regulation, phase balancing, and the like.

Improved operation can reduce input and/or output ripple characteristics, reduce EMI, reduce stress on components, and/or reduce filtering requirements.

Enables the elimination of discontinuity of input and output currents.

Enables four quadrant operation of buck, boost, bidirectional buck, and bidirectional boost.

Provides a filtered output in all quadrant modes of operation.

Embodiments selectively enable six or more of the following operational modes of: DC1DC2 buck, DC1DC2 boost, DC2DC1 buck, DC2DC1 boost, DC1DC2 bridge, AC1DC1 boost, AC1DC2 boost, DC1AC1 buck, DC2AC1 buck. Where DC1 represents the first DC interface 101, DC2 the second DC interface 102, and AC1 the AC interface 103.

Can bridge DC links to provide an unregulated output, or pass through power without switching efficiency losses.

Embodiments are able to charge either DC source from the AC source, and invert either DC source to the AC source.

Able to direct power flow in any direction between two DC sources or sinks, and one AC source or sink.

Can be used to improve the voltage range of a converter.

Can be used to improve the power range of a converter.

Can be used with or without transformer.

Can use multiple converters to increase power output.

Can use multiple converters to reduce ripple.

Improved filtering of ACDC, DCAC and/or DCDC conversions.

Can parallel multiple converters to provide a power output derived from multiple input sources.

Can parallel multiple converters operating in different operational modes to provide versatile input and output characteristics and load profiles.

Can operate multiple converters in series to widen voltage range, or to transfer energy between multiple sources.

Can control the power flow between three sources by linking the DC bus of two DC sources.

Can accommodate storage elements of different capacities, voltages, state-of-health, or the like.

Can provide cost effective active balancing between multiple smaller storage elements.

Can easily accommodate and amalgamate second life batteries of varied state-of-health, and orchestrate in aggregate.

Can increase the charging voltage thereby allowing for lower currents and therefore losses between charging station and electric vehicle.

Elements of the disclosure/s may also be further described as follows. A multimodal converter for an inductive load including: a converter (110) of one or more drive circuit phases (111,112,113,114,115,116) connected to one or more inductive load phases (161,162,163), an interface to a AC current source or sink of one or more phases (103), an interface to an DC current source or sink (101), an interface to a further DC current source or sink (102), a switching mechanism (120, 150-119-130 or 170-141, 142), and a controller (300) which operates in a first state and a second state, wherein; in the first state the controller uses the switching mechanism to selectively connects the inductive load phases to the AC one or more phases such that a filtered AC load current can be drawn and rectified by converter (110) to supply DC power to either one of the DC current sources or sinks; and wherein in a second reconfigured state, the controller uses the switching mechanism to selectively disconnect at least one inductive load phase (161, 162, 163) from at least one of the phases of the AC interface (103), and use the drive circuit phases of converter (110) to transfer a DC current through at least one of the inductive load phases (161,162,163) between the two interfaces of DC current sources or sinks (101,102), where the DC input and the DC output of the conversion is filtered.

In one embodiment or variation of the second state, the multimodal converter is a four-quadrant DCDC converter, able to selectively perform a DC to DC conversion in any modes of buck, boost, or bidirectional buck, or boost. In one embodiment the multimodal converter has interfaces for at least two DC sources, and at least one AC source, and wherein the converter is able to control power flow direction between any two sources. In one embodiment the switching mechanism includes a first switching mechanism (150) for selectively connecting the first DC interface (101), and a second switching mechanism (120) for selectively connecting the second DC interface (102), wherein the first state the controller enacts either the first switching mechanism or the second switching mechanism. In one embodiment the second state, the switching mechanism includes a third switching mechanism (123 or 153) to connect at least one of the one or more inductive loads (161,162,163) which was disconnected from the AC interface (103) to at least one of the DC interfaces (101,102). In one embodiment or variation, the inductive load has two or more phases, and the third switching mechanism is able to connect at least one of the two or more phases to the first DC interface (101), and another phase to the second DC interface (102) simultaneously. In one embodiment in the second state, at least two of the inductive load phases are selectively electrically bridged (141, 142) on the side not connected to the drive (110). In one embodiment in the second state, the converter is able to perform a sequential DC to DC conversion of boost then buck. In one embodiment in the second state at least one of the inductive loads are selectively coupled to at least one of the DC source or sink interfaces. In one embodiment the multimodal converter defines, at least in part, an electric vehicle charging station, and wherein, one of the DC current source or sink is an electric vehicle coupled to the charging station. In one embodiment the multimodal converter provides a filtered output of continuous current to the electric vehicle. In one embodiment the multimodal converter defines, at least in part, an electric vehicle charging station, and wherein, the further DC current source or sink is an attached DC energy storage system. In one embodiment the attached DC energy storage system is comprised of a battery or a capacitor. In one embodiment the electric vehicle charging station includes a communications module for assisting in the decision of which mode (ACDC or DCDC) to operate. In one embodiment the multiple converters are able to operate in parallel.

The disclosure/s may also be described as follows. An electric vehicle charging station including; an active rectifier of one or more phases, at least one inductive load for each phase, a connection to an AC energy source or sink, a connection to a DC energy source or sink integrated in or connected to the charging station, a coupler for coupling with an electric vehicle including a DC energy source, a switching mechanism, and a controller for operating the charging station wherein; in a first mode of operation, the charging station draws energy from the AC grid and supplies it to the DC energy source, and wherein in a second mode of operation the stations draws energy from the DC energy source and supplies it to an electric vehicle coupled to the charging station.

In one embodiment there exists a controller for an electric vehicle charging station connected to both an AC and a DC source of energy. Wherein the controller orchestrating multiple multi-modal converters where each converter can act independently in ACDC, bidirectional DCDC, or DCAC modes. Wherein the controller is able to selectively control the modes of each of the converters to charge an electric vehicle while drawing a dynamic amount of power of the grid, or attached DC storage.

Reference in the above embodiments to control signals is to all signals that are generated by a first component and to which a second component is responsive to undertake a predetermined operation, to change to a predetermined state, or to otherwise be controlled. The control signals are typically electrical signals although in some embodiments they include other signals such as optical signals, thermal signals, audible signals and the like. The control signals are in some instances digital signals, and in others analogue signals. The control signals need not all be of the same nature, and the first component is able to issue different control signals in different formats to different second components, or to the same second components. Moreover, a control signal can be sent to the second component indirectly, or to progress through a variety of transformations before being received by the second component.

The terms “controller”, “converter”, “module” and the like are used in this specification in a generic sense, unless the context clearly requires otherwise. When used in a generic sense, these terms are typically interchangeable.

It will be appreciated that the disclosure above provides various significant improvements in a multimodal converter.

It should be appreciated that in the above description of exemplary embodiments of the disclosure, various features of the disclosure are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure. Similarly, the Summary is also included with Detailed Description in describing the disclosure.

Furthermore, while some embodiments described herein include some but not other features included in other embodiments, combinations of features of different embodiments are meant to be within the scope of the disclosure, and form different embodiments, as would be understood by those skilled in the art.

In the description provided herein numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term “coupled” or “connected”, when used in the description, should not be interpreted as being limited to direct connections only. The terms “coupled” and “connected,” along with their derivatives, may be used. It should be understood, for example, that the terms “coupled” and “directly coupled” are not intended as synonyms for each other. Thus, the scope of the expression “a device A connected to a device B” should not be limited to devices or systems wherein an output of device A is directly connected to an input of device B. Rather, it means that there exists a path between an output of A and an input of B which may be a path including other devices or means. “Connected” may mean that two or more elements are either in direct physical or electrical contact, or that two or more elements are not in direct contact with each other but yet still co-operate or interact with each other. Similar terms are also interpreted similarly. By way of example, the terms “mounted to” or “fixed to” should not be limited to devices wherein a first element is mounted directly to or fixed directly to a second element. Rather, it means that there exists a mounting of fixing between the two that is able to, but does not have to, include intermediate elements.

Thus, while there has been described what are believed to be some embodiments of the disclosure, those skilled in the art will recognize that other and further modifications may be made thereto without departing from the spirit of the disclosure, and it is intended to claim all such changes and modifications as falling within the scope of the disclosure. For example, any formulas or flowcharts provided are merely representative of procedures that may be used. Functionality may be added or deleted from the block diagrams and operations may be interchanged among functional blocks. Steps may be added or deleted to methods described within the scope of the present disclosure.

1. A multimodal converter for an inductive load including:
a converter of one or more drive circuit phases connected to one or more inductive load phases;
a first interface to an AC current source or sink of one or more phases;
a second interface to an DC current source or sink;
an interface to a further DC current source or sink;
a switching mechanism; and
a controller which operates in a first state and a reconfigured, second state;
wherein in the first state the controller uses the switching mechanism to selectively connect the one or more inductive load phases to the AC of one or more phases such that a filtered AC load current can be drawn and rectified by the multimodal converter to supply DC power to either one of the DC current sources or sinks;
wherein in the reconfigured second state the controller uses the switching mechanism to selectively disconnect at least one inductive load phase from at least one of the phases of the AC interface, and use the drive circuit phases of the converter to transfer a DC current through at least one of the inductive load phases between the two interfaces of the DC current, the further DC current source, or sinks; and
wherein a DC input and a DC output of the conversion is filtered.

2. The multimodal converter according to claim 1, wherein the reconfigured second state of the multimodal converter is reconfigured into a four-quadrant DCDC converter that is able to selectively operate in at least one of a buck mode, a boost mode, a bidirectional buck mode and a bidirectional boost DC to DC conversion mode between the DC current source or sink and the further DC current source or sink.

3. The multimodal converter according to claim 1, wherein the multimodal converter has interfaces for two DC sources, and one AC source, and wherein the converter is able to control power flow direction between any two sources.

4. The multimodal converter according to claim 1, wherein the switching mechanism includes a first switching mechanism for selectively connecting the first DC interface, and a second switching mechanism for selectively connecting the second DC interface,
wherein in the first state the controller enacts or causes to act either the first switching mechanism or the second switching mechanism.

5. The multimodal converter according to claim 4, wherein in the reconfigured second state, the switching mechanism includes a third switching mechanism to connect at least one of the one or more inductive load phases which was disconnected from the AC interface to at least one of the DC interfaces.

6. The multimodal converter according to claim 5, wherein the inductive load has two or more phases, and the third switching mechanism is able to connect at least one of the two or more phases to the first DC interface, and another phase to the second DC interface simultaneously.

7. The multimodal converter according to claim 1, wherein in the reconfigured second state, at least two of the one or more inductive load phases are selectively electrically bridged on a side not connected to the drive circuit.

8. The multimodal converter according to claim 5, wherein in the second reconfigured state at least one of the one or more inductive load phases are selectively coupled to at least one of the DC source or sink interfaces.

9. The multimodal converter according to claim 1, wherein the multimodal converter defines at least in part an electric vehicle charging station, and wherein one of the DC current source or sink is an electric vehicle coupled to the electric vehicle charging station.

10. The multimodal converter according to claim 9, wherein the multimodal converter provides a filtered output of continuous current to the electric vehicle.

11. The multimodal converter according to claim 1, wherein the multimodal converter defines at least in part an electric vehicle charging station, and wherein the further DC current source or sink is an attached or coupled with a DC energy storage system.

12. The multimodal converter according to claim 1, wherein multiple converters are able to operate in parallel.

13. A controller for an electric vehicle charging station including:
an interface to an AC current source or sink,
an interface to an DC current source or sink,
an interface to an electric vehicle,
a multimodal converter including a switching mechanism, and
wherein the controller operates in a first state and a second state;
wherein in the first state the controller uses the multimodal converter to draw current from the AC current source or sink, to provide at least one of a regulated current or voltage to the DC current source or sink; and
wherein in the second state the controller uses the multimodal converter to connect the interface of the DC current source or sink with the interface of the electric vehicle such that the electric vehicle can use an onboard converter to regulate at least one of a regulated charging current or voltage.

14. A controller for an electric vehicle charging station including:
two or more DC interfaces and two or more corresponding electric vehicle interfaces;
a common power supply bus;
one or more converters connected between the two or more DC interfaces and/or electric vehicle interfaces and the common power supply bus;
a further DC interface for an electric vehicle or a storage device connected to the common power supply bus; and
wherein the controller operates in a first state and a second state;
wherein in the first state the controller uses the one or more converters to draw current from the common power supply bus to provide at least one of a regulated current or voltage to at least one of the two or more DC interfaces and/or the corresponding electric vehicle interfaces; and
wherein the second state the controller uses at least one of the one or more converters to draw energy from at least one of the two or more DC interfaces and/or corresponding electric vehicle interface to provide at least one of the regulated current or voltage to the further DC interface.
